(19) United States
(12) Patent Application Publication
(10) Pub. No.: US 2026/0368507 A1
(43) Pub. Date: Nov. 19, 2026

(54) Neural Network Compression via Latent-Space Approximation of Module Interactions

(71) Applicant: Mitsubishi Electric Research Laboratories, Inc., Cambridge, MA (US)

(72) Inventors: Toshiaki Koike-Akino, Boston, MA (US); Xiangyu Chen, Lawlence, KS (US); Jing Liu, Santa Clara, CA (US); Ye Wang, Andover, MA (US)

(73) Assignee: Mitsubishi Electric Research Laboratories, Inc., Cambridge, MA (US)

(21) Appl. No.: 19/257,124

(22) Filed: Jul. 1, 2025

Related U.S. Application Data
(60) Provisional application No. 63/799,929, filed on May 5, 2025.

(51) Int. Cl. G06N 3/0495; G06N 3/0455

(52) U.S. Cl. CPC G06N 3/0495; G06N 3/0455

(57) ABSTRACT

A neural network model includes an input module, a first module with a first weight matrix, and a second module with a second weight matrix. The first and second modules are functionally coupled and transform input data into output data based on their interaction. This interaction is approximated using a compressed representation. The compressed representation includes a latent input projection matrix that projects input data into a reduced-dimensional latent space, and a core matrix or tensor in that space that approximates the original interaction. An output module provides a result based on the compressed interaction. Additionally, the model supports compression techniques including compression, quantization, and pruning based on a precondition matrix. These processes may be sequential or joint. The architecture supports efficient inference with fewer parameters and lower computational cost while preserving fidelity.

### TECHNICAL FIELD

The present disclosure relates generally to machine learning systems and artificial intelligence architectures. More specifically, it pertains to techniques for compressing and executing neural network models using latent-space representations of interactions between functionally coupled components, such as weight matrices in multi-layer architectures. Embodiments described herein may be applicable to various artificial intelligence models, including but not limited to convolutional neural networks (CNNs), recurrent neural networks (RNNs), transformer networks, large language models (LLMs), large multimodal models (LMMs), denoising diffusion models, and other deep learning architectures. These techniques may support improved computational efficiency, reduced memory footprint, and enhanced fidelity in inference computations through compressed representations that preserve key functional behaviors of the original model.

### BACKGROUND

Artificial intelligence (AI) systems increasingly rely on deep neural networks composed of multiple interconnected layers and parameterized modules. These systems are widely used in applications such as natural language processing, computer vision, speech understanding, and multimodal reasoning. As neural network architectures grow in depth and complexity, so too do the computational and memory demands associated with storing and executing their parameters, particularly weight matrices used in dense and attention-based layers.

To address these challenges, various model compression techniques have been developed. Common strategies include quantization, pruning, and matrix factorization methods such as singular value decomposition (SVD) or other low-rank approximations. These approaches aim to reduce model size, accelerate inference, and lower energy consumption, thereby enabling deployment in resource-constrained environments such as edge devices or real-time processing systems.

Despite widespread use, traditional compression methods face several limitations. These techniques are often designed to operate on individual components of a neural network, such as single weight matrices or layers, without fully capturing broader architectural context. This localized focus can result in performance degradation or necessitate additional fine-tuning to restore accuracy. In some cases, compression is performed as an offline step and may not yield meaningful improvements in inference-time efficiency, particularly if the compressed forms must be expanded or transformed prior to execution.

As neural networks continue to evolve, their architectures increasingly incorporate modular and repeating structures-such as multi-head attention mechanisms, stacked encoder-decoder layers, and multi-layer perceptron blocks. These patterns introduce new challenges for compression approaches, which must balance compactness with the need to preserve architectural consistency and runtime performance. Techniques that offer greater flexibility across different layers or configurations, while maintaining fidelity to the original model behavior, remain an area of ongoing interest.

Accordingly, there remains a need for improved methods to represent and execute neural network computations more efficiently, with a focus on reducing model complexity and computational cost while maintaining predictive accuracy and preserving runtime behavior.

### SUMMARY

Embodiments described herein relate to systems and methods for compressing and executing neural network models using latent-space representations of interactions between functionally related components. These techniques are applicable to a broad range of artificial intelligence (AI) architectures, including, but not limited to, convolutional neural networks (CNNs), recurrent neural networks (RNNs), feedforward neural networks, transformer networks, denoising diffusion models, large language models (LLMs), large multimodal models (LMMs), vision-language models (VLMs), state-space models, and other deep learning frameworks.

In many of these architectures, predictive behavior is governed by structured interactions among pairs or groups of parameterized modules-such as query and key projections in attention mechanisms, encoder-decoder layers in sequence models, or up- and down-projection layers in multi-layer perceptrons (MLPs). These interactions, often mediated by weight matrices, span spatial, temporal, or modality-specific dimensions. Certain embodiments recognize that such interactions are often approximated or represented within a shared, lower-dimensional latent space. Although not always explicitly encoded in conventional architectures, this latent subspace may underlie key computational behaviors and, in embodiments, leveraged to improve model efficiency and interpretability.

To reduce computational and memory overhead while preserving functional behavior, various embodiments implement a compressed representation of these interactions. Rather than relying on traditional full-rank matrix computations, the compressed representation includes a latent input projection matrix that maps input data into a reduced-dimensional latent space, and a core matrix or tensor that operates within that latent space to approximate the interaction between the coupled components.

In this context, identifying and operating within a latent interaction structure—where functional relationships between modules are preserved or reconstructed—in embodiments, enable compression techniques that more faithfully capture the computational semantics of the original model. In some implementations, functionally coupled weight matrices may be jointly projected into the shared latent subspace, and their interactions represented through the core tensor. This approach can reduce parameter redundancy, eliminate unnecessary decompression steps, and more accurately preserve architectural structure, thereby improving both memory and computational efficiency with minimal impact on accuracy.

Embodiments may employ joint optimization strategies, latent subspace projection techniques, and tensor decomposition methods—such as Tucker decomposition—to derive the compressed representation. In certain implementations, the compressed representation is obtained directly from the model's weight matrices. In others, it is generated from latent parameters using hypernetworks or compact implicit neural networks. The resulting interaction structure, in embodiments, is embedded directly into the model's inference path, enabling compressed execution without reconstructing the full matrices.

By enabling interactions to occur directly in latent space, various embodiments reduce model size, decrease the number of floating-point operations, and lower memory bandwidth requirements. These improvements are particularly advantageous in architectures with repeated or tightly coupled modules—such as large transformer models and multimodal systems—where runtime efficiency is critical. The approach is compatible with existing neural architectures and generalizes across different layer types, allowing seamless integration without substantial reengineering.

As a result, the disclosed systems and methods support more efficient deployment of AI models in compute-constrained environments, including edge devices, mobile platforms, and latency-sensitive applications. In addition, the ability to compress and execute models without requiring retraining or fine-tuning reduces development costs and accelerate production readiness. Collectively, these embodiments provide scalable, flexible, and high-performance solutions for delivering modern AI models across a wide range of platforms and use cases.

Some embodiments are based on the realization that high AI performance is maintained by considering a global statistical impact across multiple modules when jointly compressing the multiple modules of the AI model, instead of approximating the parameters of each module individually. For example, a joint high-order tensor decomposition for a pair of query and key projection modules typically improve the compression efficiency and model accuracy. Some embodiments are based on joint value-output projection, joint up-down projection compression used in typical transformer architecture. To reduce the computational resource of AI systems, some embodiments provide the solution to convert a pre-trained large AI model into a small AI model through a transformation based on latent dimension reduction. The solution of some embodiments reduces the approximation loss by considering multiple coupled modules at once. Latent reduction is applied across multiple modules to reduce a final loss without the need of gradient calculations, involving high-order tensor rank decomposition. Joint multi-head attention optimization is provided. Also, joint layer MLP optimization is provided.

Some embodiments rely on that a set of compressed architectures is determined using a statistical information between input and output activation features at a set of coupled modules given some calibration data. For example, statistical information includes covariance and its variants as a pre-conditioning matrix to improve the compression efficiency.

Yet another embodiment uses a control of junction matrices, to further reduce the computational demands by formulating into a block identity format or a triangular matrix format. Further, tensor decomposition with dynamically customized tensor networks for each module can reduce the approximation loss.

Yet another embodiment provides the way to improve the approximation accuracy by imposing nonlinearity in the latent representation. It includes simple MLP structures and SwiGLU structures. It also extends the latent structure in nested hierarchy. Then, the kernelized latent representation including Fourier, Chebyshev, Legendre, spline expansions, in embodiments, improves the capability of latent space representations. For example, some embodiments use explicit latent processing, where low-dimensional latent tensors are generated by nonlinear projection from input features and weights, and then the latent tensors are further projected to output features with weights. Some other embodiments use the implicit latent processing, where low-dimensional latent tensors are implicitly determined by a nonlinear function with input, output, and weight interaction. For example, hypernet and implicit neural representation (INR) projection are used to generate weight parameters from latent parameters one by one by feeding the tensor index.

The explicit and implicit latent processing to reduce the model size can be integrated with joint quantization/pruning/fine-tuning. Some embodiments demonstrate the advantage in modern LLM architectures such as ViT, LLaMa, LLaVA, and OPT. However, the disclosure can be applied to many other architectures including DDPM, CNN, ResNet, and CLIP.

Some embodiments of a system for executing an AI task use a memory storage to keep an intermediate data and a set of parameters for an AI model and a processor configurerd to access the memory storage for controlling a flow of an input data according to the AI model, wherein the AI model uses a set of compressed architectures to transform the input data into an output data as an output for the AI task according to the set of parameters. The AI task is based on a natural language processing, computer vision processing, biosignal processing, audio/speech processing, and a variant thereof, including image classification/segmentation, object/human identification, pose/emotion estimation, image/text/speech generation, medical diagnosis, monitoring, traffic question answering, video cationing/summarization, coding assistance, decision making, planning, and translation. The AI model is based on an artificial neural network including a convolutional neural network, recurrent neural network, feed forward network, transformer network, denoising diffusion model, large language model, large mulimodal model, vision language model, state-space model, and a variant thereof. The set of compressed architectures is based on a tensor rank decomposition, quantization, pruning, hypernet, tensornet, skipping, fusing, random projection, and a combination thereof. For some embodiments, the AI model uses multihead latent attention, nonlinear latent projection, latent multilayer perceptron, latent gated linear unit, nested latent layer, latent implicit hypernet, and a variant thereof. The set of compressed architectures is determined based on a set of preconditioning, permutation, and junction matrices according to a set of statistics for a set of coupled modules to reduce the number of parameters by converting a pretrained AI model. The set of statistics is based on intermidiate features calculated with a set of calibration data and its statistical moments including mean, covariance, skewness, kurtosis, root-covariance, covariance norm, tensor norm, Hessian matrix, Jacobian matrix, and a variant thereof.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a block diagram illustrating an example architecture of a neural network model comprising functionally coupled modules that interact using a compressed representation in a latent space, in accordance with some embodiments.

FIG. 2 is a schematic diagram showing the transition from a full-rank interaction between two weight matrices to a compressed interaction performed via a latent input projection matrix and a core matrix or tensor.

FIG. 3 is a flow diagram illustrating a method for generating a compressed representation of an interaction between weight matrices, including projection into a latent space and execution of the interaction using latent components.

FIG. 4 is a diagram illustrating an example attention mechanism using the disclosed compressed representation to approximate a query-key interaction.

FIG. 5 is a diagram depicting a variation in which a hypernetwork generates the latent projection matrix or core matrix based on learned latent parameters.

FIG. 6 is a diagram illustrating an example joint multi-head query-key compression.

FIG. 7 is a diagram illustrating an example Latent MLP using the disclosed compressed representation to approximate the MLP layers.

FIG. 8 is a diagram illustrating an example Latent SwiGLU using the disclosed compressed representation to approximate the SwiGLU layer.

FIG. 9 is a diagram illustrating an example of using hypernetworks to generate compressed representations.

FIG. 10 is a diagram illustrating an example of disclosed compressed representations where there are nonlinear operations between low-rank matrices.

FIG. 11 is a diagram illustrating an example of disclosed compressed representations where the low-rank matrices are further quantized.

FIG. 12 is a diagram illustrating an example of disclosed compressed representations where the low-rank matrices are further pruned/sparsified.

FIG. 13 is a diagram illustrating an example of disclosed compressed representations where the ranks of the low-rank matrices are adaptive/nonuniform for different components.

FIG. 14 is a diagram illustrating sequential low-rank compression and pruning, according to some embodiments of the present disclosure, according to embodiments of the present disclosure.

FIG. 15 is a flow diagram illustrating joint low-rank compression and pruning, according to some embodiments of the present disclosure.

FIG. 16 is a diagram illustrating an example of sequential low-rank compression, quantization, and pruning, according to some embodiments of the present disclosure.

FIG. 17 is a diagram illustrating an example of sequential low-rank compression, pruning, and quantization, according to some embodiments of the present disclosure.

FIG. 18 is a diagram illustrating an example of sequential low-rank compression followed by joint pruning and quantization, according to some embodiments of the present disclosure.

FIG. 19 is a diagram illustrating an example of joint low-rank compression and pruning followed by quantization, according to some embodiments of the present disclosure.

FIG. 20 is a diagram illustrating an example of joint low-rank compression and quantization followed by pruning, according to some embodiments of the present disclosure.

FIG. 21 is a diagram illustrating an example of joint low-rank compression, quantization, and pruning, according to some embodiments of the present disclosure.

FIG. 22 is a diagram illustrating an example of a pruned latent input projection matrix, according to some embodiments of the present disclosure.

FIG. 23 is a diagram illustrating a Tucker decomposition applied to a joint interaction tensor, according to some embodiments of the present disclosure.

FIG. 24 is a diagram illustrating a preconditioning strategy for generating compressed representations from original model weights, according to some embodiments of the present disclosure.

FIG. 25 is a diagram illustrating the use of a junction matrix J to enforce an identity structure in the left part of the compression matrix, according to some embodiments of the present disclosure.

FIG. 26 is a diagram illustrating two conceptual frameworks for latent-space computation: explicit latent processes and implicit latent processes, according to some embodiments of the present disclosure.

FIG. 27 is a diagram illustrating an implicit neural representation architecture where a latent representation is used to generate individual elements of a weight tensor, according to some embodiments of the present disclosure.

FIG. 28 is a schematic illustrating dynamic tensornet methods to compress weight parameters by exploring different topologies for reconfigurable decomposed tensors, according to some embodiments of the present disclosure.

FIG. 29 is a schematic illustrating dynamic tensornet methods to compress weight parameters by exploring different topologies through tensor folding, according to some embodiments of the present disclosure.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Recent AI systems based on large language models (LLMs) have shown excellent performance across a variety of general tasks. Nonetheless, these models having billions of parameters demand significant computational resources. To make LLMs more accessible and greener, the present disclosure provides methods and systems to compress the AI models with integrated partial activation, pruning, quantization, knowledge distillation, and low-rank factorization. The solution of the present disclosure efficiently reduces the model size and computational resource by employing reduced-dimension LLM. The solution or method employs a low-rank architecture called multi-head latent attention (MLA) to compress a regular multi-head attention (MHA), realizing an efficient KV cache, accelerated training and high-performance inference. The present disclosure provides an efficient solution to convert a pretrained LLM having MHA into a compressed LLM having MLA. The approach is based on a global compression framework, which jointly reduces multiple modules at once, while no gradient calculations are required. For example, query and key projections used in attention modules are jointly compressed in a latent representation via high-order tensor rank decomposition. Some embodiments further extend it to the joint compression of multi-layer perceptron (MLP). For example, joint up/down projections are compressed with a decoupled loss minimization. The solution is based on a high-order tensor-rank decomposition to jointly factorize multiple linear layers. Some embodiments use an optimal pre-conditioning for activation-aware SVD to deal with the activation statistics. Yet another embodiment provides a way to optimize a choice of junction matrix to significantly reduce the model size. The high-order Tucker decomposition, in embodiments, jointly compresses multiple weights at the same time. Some embodiments further explore different tensor diagrams and topologies such as max product state (MPS) and tree tensor network (TTN) to search for the best compressive architectures. For example, tensor folding, tensor renormalization and hyperparameter search are performed to reduce the model size and to improve the model accuracy. Some experiments over several LLM/VLM benchmarks validate that the provided approach can improve the performance of model compression over existing methods.

### Tensor Compression: Reduced-Dimension AI System

Some embodiments are based on low-rank tensor decomposition to reduce the AI model size and computational cost. The present disclosure provides a solution that multiple linear modules are globally compressed by attention-aware tensor decomposition, instead of local compression with activation-aware tensor decomposition. Most AI systems use multi-layer perceptron (MLP) and multi-head attention (MHA) modules. For example, LLM models based on LLaMA use the transformer architecture having MHA and MLP. For MLP, there are up and down projections, whereas MHA has query/key/value/output projections for typical LLMs and VLMs. By transforming those dense weight matrices into low-rank decompositions, some embodiments can realize an efficient latent LLM having potential benefits: (i) fewer-parameter model size; (ii) KV cache reduction; (iii) accelerated processing; (iv) lower-power consumption. In fact, some recent LLM models such as DeepSeek-V3 showed an efficient and high-performance capability with the MLA. Nevertheless, there is no straightforward solution to efficiently convert MHA to MLA without sacrificing AI accuracy. The present disclosure, in embodiment, compresses a pre-trained LLM by converting MHA into MLA in a zero-shot fashion, i.e., without the need of any fine-tuning or gradient updates.

Most existing compression methods are based on a local loss minimization to approximate each weight individually. The present disclosure is based on a recognition that a global optimization based on a joint tensor compression framework can reduce the approximation error effectively. Specifically, some embodiments provide a solution to decompose a pair of query and value projections, a pair of value and output projections, and a pair of up and down projections jointly.

### Activation-Aware SVD: Pre-Conditioning

Some embodiments are based on Adaptive SVD (ASVD) which provides a way to compress a layer depending on the activation statistics. Consider a pretrained-weight W∈ [symbol] ^{d′×d} to compress with a lower-rank decomposition Ŵ=BA for compression matrix A∈ [symbol] ^{r×d} and decompression matrix B∈ [symbol] ^{d′×r}. Using the input activation X∈ [symbol] ^{d×l} (l is the calibration sample length), ASVD aims at minimizing the activation loss:

[symbol]

₁= [symbol] _{X}∥WX−ŴX∥²= [symbol] _{X}∥WX−BAX∥², (1)

instead of the naïve weight-based loss:

[symbol]

₀=∥W−Ŵ∥²=∥W−BA∥². (2)

The optimal solution to minimize [symbol] ₀ can be given by the plain SVD of W. To minimize [symbol] ₁, ASVD introduced a pre-conditioning matrix P∈ [symbol] ^{d×d} to whiten the statistical impact of the activation X. Specifically, ASVD uses the low-rank matrices given by whitened SVD:

BAP=svdᵣ[WP], (3)

where svdᵣ[·] denotes the rank-r truncated SVD.

The optimal pre-conditioning matrix P, in embodiments, is given by reformulating [symbol] ₁ as follows:

$${ℒ}_{1} = t r [ ( W - BA ) {𝔼}_{X} [ {XX}^{T} ] {( W - BA )}^{T} ] \qquad ( 4 )$$

$$= {‖ ( W - BA ) {C}^{\frac{1}{2}} ‖}^{2} = {‖ {WC}^{\frac{1}{2}} - {BAC}^{\frac{1}{2}} ‖}^{2} , \qquad ( 5 )$$

where C= [symbol] _{X}[XX^{T}]∈ [symbol] ^{d×d} is a covariance (precisely, auto-correlation) of the input activation. Hence, the above loss, in embodiments, is minimized by the SVD:

$${BAC}^{\frac{1}{2}} = {svd}_{r} [ {WC}^{\frac{1}{2}} ] .$$

Accordingly, the optimal pre-conditioner is identified as the square-root covariance:

$$P = {C}^{\frac{1}{2}} .$$

Given a finite calibration data X, some embodiments estimate the covariance as C=XX^{T}+λI, where the damping factor λ∈ [symbol] ₊ corresponds to the shrunk estimator.

Different pre-conditioning methods, in embodiments, are used. For example, some choices of pre-conditioning matrix include:
Identity: I
Diagonal Hessian:

$${diag [ {( {XX}^{⊤} + λ I )}^{- 1} ]}^{\frac{- 1}{2}}$$

Diagonal [symbol] ₁-norm: diag[Σⱼ|X_{1,j}|, . . . , Σⱼ|X_{d,j}|]^{b}
Diagonal [symbol] ₂-norm:

$${diag [ {XX}^{⊤} ]}^{\frac{1}{2}}$$

Covariance power: (XX^{T}+λI)^{a} Diagonal covariance power: diag[(XX^{T}+λI)^{a}]^{b}
Diagonal row-covariance power: diag[(XX^{T}+λI)^{a}]^{b}
Diagonal column-covariance power: diag[1^{T}(XX^{T}+λI)^{a}]^{b}
   Here, a and b are scalar values used as adjustable hyperparameters.

Some embodiments provide a way to explore different pre-conditioning matrices depending on the available compute resource. For example, diagonal matrix, in embodiments, simplifies the compression with pruning and quantization. Yet in another embodiments, the pre-conditioning matrix is computed on the fly for every input feature to enable instant test-time compression regardless of downstream tasks. This embodiment can reduce the inference compute by reducing the model size dynamically at the inference time, realizing a mixture system of micro-experts. In addition, the hyperparameters, such as covariance power and damping factor, are dynamically optimized depending on the calibration data, e.g., with Bayesian optimization. In the presence of a bias term, the optimal solution is modified accordingly. Scaling the covariance has no impact in the performance, and therefore, in embodiments, is often normalized as C=(XX^{T}+λI)/l.

### Junction Matrix for Model Compression

Some embodiments are based on the recognition that the solution in Eq. (3) has non-unique expression to decompose into low-rank matrices B and A. Specifically, any arbitrary non-singular junction matrix J∈ [symbol] ^{r×r} has the exact same loss as below. The truncated SVD is written as

USV=svdᵣ[WP], (6)

where U∈ [symbol] ^{d′×r}, S∈ [symbol] ^{r×r}, and V∈ [symbol] ^{r×d} are left singular unitary matrix, singular-value diagonal matrix, and right singular unitary matrix, respectively. The decompression and compression matrices B and A, in embodiments, are expressed as

B=USJ, (7)

A=J⁺VP⁺, (8)

where [·]⁺ denotes the pseudo inverse. Any junction matrix which holds SJJ⁺=S has no impact to the loss. Hence there is no prior-art discussing on the choice of J, and typically, one may use J=I to put singular-values into decompression matrix; J=S⁺ to put this into compression matrix; or

$$J = {[ {S}^{\frac{1}{2}} ]}^{+}$$

to split the eigenvalues into both matrices equally.

However, a certain choice of J has a noticeable advantage to reduce the number of parameters and floating-point operations (FLOPs). Write the whitened right-singular matrix VP⁺ into two sub-blocks:

VP⁺=[V₁ V₂], (9)

for V₁∈ [symbol] ^{r×r} and V₂∈ [symbol] ^{r×(d-r)}. When some embodiments use J=V₁, the compression matrix A is a block identity as long as V₁ is non-singular:

$$A = {J}^{+} {VP}^{+} = {V}_{1}^{+} [ \begin{matrix}{V}_{1} & {V}_{2}\end{matrix} ] = [ \begin{matrix}I & {V}_{1}^{+} {V}_{2}\end{matrix} ] . \qquad ( 10 )$$

This, in embodiments, reduces the number of parameters from r(d′+d) to r(d′+d)−r², as well as the FLOPs because no operation for the identity projection. Some embodiments are based on this choice of junction matrix to realize low-power AI systems with fewer FLOPs.

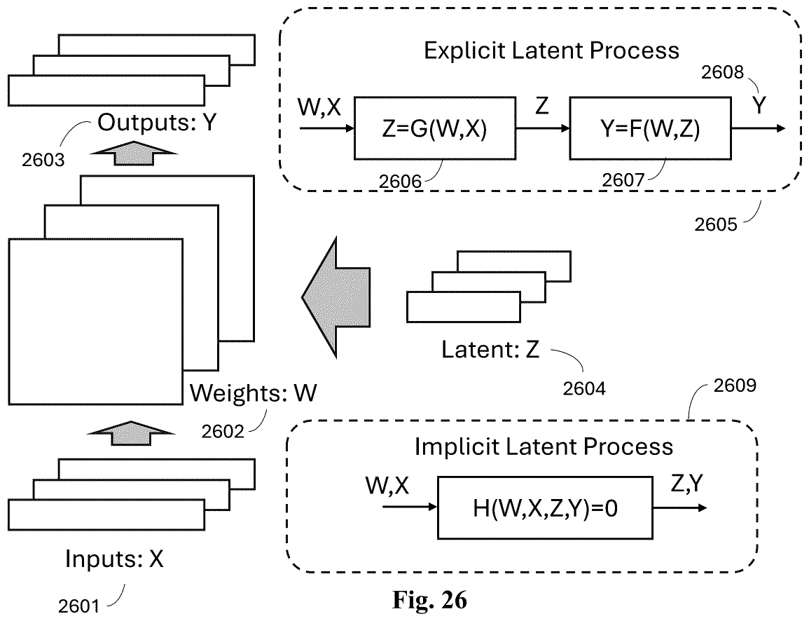

For example, when the hidden size is d=d′, even if some embodiments compress the hidden size by 25%, i.e., the latent size is r=0.75 d, the total number of parameters is r(d′+d)=1.5 d², which is 50% more than the original size d². This increased FLOPs hinder the low-rank compression of LLMs, even with the KV cache benefit. Nevertheless, with the proper junction matrix to realize the identity block form, some embodiments always reduce the number of parameters regardless of the latent size, i.e., r(d′+d)−r²<d′d for r<min(d′, d). For the above example of 25% latent compression, some embodiments achieve r(d′+d)−r²=(15/16)d²<d². FIG. 26 depicts the role of pre-conditioning and junction matrix for the activation-aware compression. FIG. 26 clarifies the flexibility of tensor mapping with a different junction matrix. For activation-aware compression, the junction matrix J, in embodiments, is adjusted such that A or B is block identity to save the number of parameters and inference computation.

Some embodiments use pivoting columns to solve the case when the left-most sub-block V₁ is singular. The pivoting does not require any FLOPs in inference while additional memory is required to record the permutation index. J=V₁ is not the only useful choice: (i) some embodiments, therefore, transforms B into a block-identity form in a similar manner; or (ii) some embodiments nullify the upper triangular of both B and A like LU factorization.

The ASVD with proper pre-conditioning is optimal in the sense that the local error is minimized for the single tensor compression, whereas ASVD with proper pre-conditioning does not guarantee the global optimality. Some embodiments extend ASVD with proper pre-conditioning with the global loss minimization framework, which provides a way of a joint tensor compression technique which factorizes multiple tensors in adjacent modules concurrently.

### Multi-Head Latent Attention: Joint QK Compression

Some embodiments are based on a joint compression of query (Q) and key (K) projections in MHA to convert into MLA. The attention map is the dot product of query and key features:

$${M}_{i} = {X}^{⊤} {W}_{q , i}^{⊤} {W}_{k , i} X , \qquad ( 11 )$$

where Mᵢ∈ [symbol] ^{l×l} is the ith head attention map before softmax operation, W_{q,i}∈ [symbol] ^{d}^{ₕ}^{×d} is the ith head query projection matrix, and W_{k,i}∈ [symbol] ^{d}^{ₕ}^{×d} is the ith head key projection matrix, respectively. Here, d is the head dimension, which is often dₕ=d/h for the number of heads h. Rather than individually compressing the Q and K projections, some embodiments consider minimizing the attention map error:

$${ℒ}_{2} = {\sum }_{i = 1}^{h} {‖ {M}_{i} - {\hat{M}}_{i} ‖}^{2} , \qquad ( 12 )$$

where \hat{M}ᵢ is the ith head latent attention with the low-rank compression:

$$\begin{matrix}a . & \\ {\hat{M}}_{i} = {X}^{⊤} {A}_{q}^{⊤} {B}_{q , i}^{⊤} {B}_{k , i} {A}_{k} X , & ( 13 )\end{matrix}$$

where A_{q}∈ [symbol] ^{r}^{_{q}}^{×d} is the Q latent compression matrix, Aₖ∈ [symbol] ^{r}^{ₖ}^{×d} is the K latent compression matrix, B_{q,i}∈ [symbol] ^{d}^{ₕ}^{×r}^{_{q}} is the ith head Q latent decompression matrix, and B_{k,i}∈ [symbol] ^{d}^{ₕ}^{×r}^{ₖ} is the ith head K latent decompression matrix, respectively. Here, r_{q} and rₖ are the latent dimensions for Q and K.

With the use of activation statistics:

$${ℒ}_{2} = {\sum }_{i = 1}^{h} {‖ {\underbrace{{C}^{\frac{1}{2}} {W}_{q , i}^{⊤} {W}_{k ,} {C}^{\frac{1}{2}}}}_{{G}_{i} ∈ {\text{?}}^{d \times d}} - \underbrace{{C}^{\frac{1}{2}} {A}_{q}^{⊤}}_{{A}_{q} {′}^{⊤}} \underbrace{{B}_{q , i}^{⊤} {B}_{k , i}}_{{H}_{i} ∈ {\text{?}}^{r} {q}^{\times {r}_{k}}} \underbrace{{A}_{k} {C}^{\frac{1}{2}}}_{{A}_{k} ′} ‖}^{2} = {\sum }_{i = 1}^{h} {‖ {G}_{i} - \\ {{A}_{q}}^{′ ⊤} {H}_{i} {{A}_{k}}^{′} ‖}^{2} . \qquad ( 14 )$$

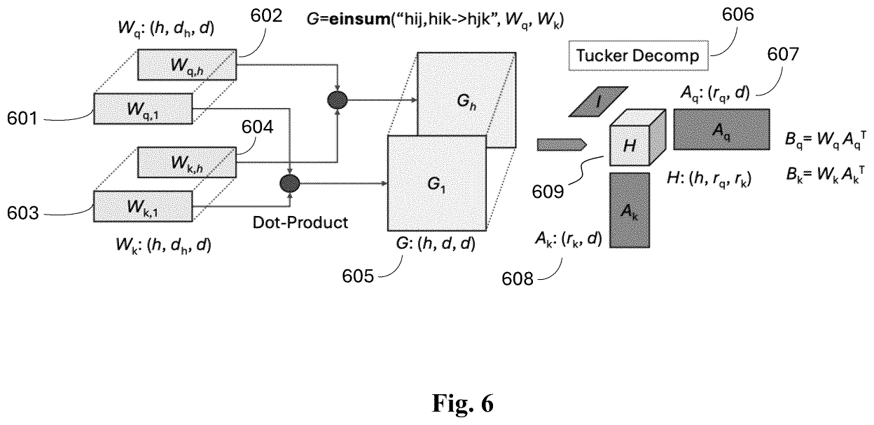

This is a high-order SVD problem to decompose for the 3-mode tensor G∈ [symbol] ^{h×d×d}, whose ith slice is Gᵢ. A_{q}′ corresponds to the 2nd tensor plane, Aₖ′ is the 3rd tensor plane, and H∈ [symbol] ^{h×r}^{_{q}}^{×r}^{ₖ} whose ith slice is Hi is the tensor core. This is illustrated in FIG. 6: Tucker decomposition for joint QK compression. The compression matrices A_{q} and Aₖ correpond to the Tucker tensor planes, while

$$H = {A}_{q} G {A}_{k}^{T}$$

is the Tucker tensor core. For simplicity, FIG. 6 omits junction matrices and pre-conditioning matrix, while using proper junction and pre-conditioning matrices, in embodiments, improve the conversion accuracy and efficiency.

This Tucker tensor decomposition is typically solved by alternating SVD over each slice sequentially. The below shows the pseudo-code of the joint SVD compression for QK latent projections.

### Input:

Pre-conditioning P∈ [symbol] ^{d×d},
Query projection heads W_{q,i}∈ [symbol] ^{d}^{ₕ}^{×d},
Key projection heads W_{k,i}∈ [symbol] ^{d}^{ₕ}^{×d},
Number of heads h,
Rank r_{q}, rₖ,
Iteration N

### Initialize:

$${W}_{q , i} = {W}_{q , i} P for i ∈ \{ 1 , … , h \}$$

$${W}_{k , i} = {W}_{k , i} P for i ∈ \{ 1 , … , h \}$$

$${G}_{i} = {W}_{q , i}^{T} {W}_{k , i} for i ∈ \{ 1 , … , h \}$$

$${A}_{q} = R i g h t S i n g u l a {r}_{{r}_{q}} [ {\sum }_{i = 1}^{h} {G}_{i} {G}_{i}^{⊤} ]$$

For n=1 to N

$${A}_{k} = R i g h t S i n g u l a {r}_{{r}_{k}} [ {\sum }_{i = 1}^{h} {G}_{i}^{⊤} {A}_{q}^{⊤} {A}_{q} {G}_{i} ]$$

$${A}_{q} = R i g h t S i n g u l a {r}_{{r}_{q}} [ {\sum }_{i = 1}^{h} {G}_{i} {A}_{k} {A}_{k}^{⊤} {G}_{i}^{⊤} ]$$

### Output:

$${B}_{q , i} = {J}_{i}^{T} {W}_{q , i} {A}_{q}^{T} {J}_{q} for i ∈ \{ 1 , … , h \}$$

$${B}_{k , i} = {J}_{i}^{+} {W}_{k , i} {A}_{k}^{T} {J}_{k} for i ∈ \{ 1 , … , h \}$$

$${A}_{q} = {J}_{q}^{+} {A}_{q} {P}^{+}$$

$${A}_{k} = {J}_{k}^{+} {A}_{k} {P}^{+}$$

Here, some embodiments generalized the pre-conditioning matrix P, as not necessarily the optimal

$$( {r}_{q} + {r}_{k} ) ( d + {d}_{h} h ) - {r}_{q}^{2} - {r}_{k}^{2} - {d}_{h}^{2} h ,$$

In addition, some embodiments explicitly denoted any arbitrary junction matrices which do not change the error but instead computational complexity. Note that there are additional junction matrices per heads Jᵢ∈ [symbol] ^{d}^{ₕ}^{×d}^{ₕ} as well as individual Q/K junctions J_{q}∈ [symbol] ^{r}^{ₖ}^{×r}^{ₖ} and Jₖ∈ [symbol] ^{r}^{ₖ}^{×r}^{ₖ}. It means that some embodiments further reduce the number of parameters by transforming into the block identity form per head. The total number of parameters are

$$( {r}_{q} + {r}_{k} ) ( d + {d}_{h} h ) - {r}_{q}^{2} - {r}_{k}^{2} - {d}_{h}^{2} h ,$$

reduced from the original weights 2ddₕh. This conversion from MHA to MLA with joint QK SVD, in embodiments, is readily applied to grouped query attention (GQA) and other variants.

The joint QK SVD, in embodiments, is extended with most positional encoding methods, including additive positional encoding, concatenative positional encoding, multiplicative positional encoding, and rotary positional encoding with a slight modification. For example, for the rotary positional encoding, the tensor axis over the heads is extended by the context window before Tucker decomposition. Some embodiments extend the compression of joint QK projections to joint QKV projections. In the presence of a bias term, the solution is modified slightly.

### Multi-Head Latent Attention: Joint VO SVD

Some embodiments are based on the joint SVD for value (V) and output (O) projections in MHA. The MHA output, in embodiments, is written as

$${Y}^{′} = {\sum }_{i = 1}^{h} {W}_{o , i} {W}_{v , i} X softmax [ {M}_{i}^{T} ] , \qquad ( 15 )$$

where W_{o,i}∈ [symbol] ^{d′×d}^{ₕ} is the ith head output projection, and W_{v,i}∈ [symbol] ^{d}^{_{h×d}} is the ith head value value projection. For any arbitrary attention map, some embodiments may consider minimizing the loss:

$${ℒ}_{3} = {\sum }_{i = 1}^{h} {‖ {W}_{o , i} {W}_{v , i} X - {\hat{W}}_{o , i} {\hat{W}}_{v , i} X ‖}^{2} , \qquad ( 16 )$$

for the low-rank compression: Ŵ_{o,i}=BₒA_{o,i}∈ [symbol] ^{d′×d}^{ₕ} and Ŵ_{v,i}=B_{v,i}Aᵥ∈ [symbol] ^{d}^{_{h×d}} with Bₒ∈ [symbol] ^{d′×r}^{ₒ}, A_{o,i}∈ [symbol] ^{r}^{ₒ}^{×d}^{ₕ}, B_{v,i}∈ [symbol] ^{d}^{ₕ}^{×r}^{ᵥ}, and Aᵥ∈ [symbol] ^{r}^{ᵥ}^{×d}. The MLA output is thus given as

$${\hat{Y}}^{′} = {\sum }_{i = 1}^{h} {B}_{o} {A}_{o , i} {B}_{v , i} {A}_{v} X softmax [ {M}_{i} ] . \qquad ( 17 )$$

This is also formulated in a similar manner of Eq. (14), and is solved by the joint SVD algorithm.

Note that the MLA computations, in embodiments, are more efficient depending on tensor contraction ordering. Specifically, Eq. (17) requires the complexity of [symbol] [ldrᵥ+hd_{d}lrᵥ+hdₕl²+hdₕlrₒ+hdlrₒ] in the order:

$${\hat{Y}}^{′} = {\sum }_{i = 1}^{h} ( {B}_{o} ( {A}_{o , i} ( ( {B}_{v , i} ( {A}_{v} X ) ) softmax [ {M}_{i} ] ) ) ) . \qquad ( 18 )$$

The above equation, in embodiments, is reduced by computing in another order:

$${\hat{Y}}^{′} = {B}_{o} {\sum }_{i = 1}^{h} ( {A}_{o , i} ( {B}_{v , i} ( ( {A}_{v} X ) softmax [ {M}_{i} ] ) ) ) . \qquad ( 19 )$$

The above equation requires the complexity of [symbol] [ldrᵥ+rᵥl²+hdₕlrᵥ+hdₕlrₒ+dlrₒ]. The reduction is [symbol] [(d−rᵥ)l²+(h−1)dlrₒ]. If hrₒ<rᵥ, then the attention weighting is done on output compression A_{o,i}. Some embodiments use different tensor rank decompositions based on adjustable network topologies such as MPS and TTN, wherein the tensor contraction is sorted such that the number of FLOPs is minimized.

Some embodiments are based on the attention-aware joint VO compression to deal with the nonlinear activation due to softmax operations. For example, the input activation statistics for the V projection is back-projected by the input activation statistics for the O projection which has softmax impact. This modification requires the alternating least-squares optimization to minimize the interaction loss of multiple modules.

### Latent MLP: Joint UD SVD

Some embodiments are based on a joint compression of MLP layers, which consists of up (U) projection and down (D) projection in typical LLMs. Although the global optimization is generally difficult due to the nonlinear activations in the MLP layer, the present disclosure provides a way to approximate the MLP layer efficiently. The key idea is to minimize the MLP loss in a decoupled manner by introducing auxiliary variables.

Consider a 2-layer MLP:

Z=WᵤX, (20)

Z′=σ(Z), (21)

Y=W_{d}Z′, (22)

where Wᵤ∈ [symbol] ^{d}^{_{i×d}} is the up projection matrix, W_{d}∈ [symbol] ^{d×d}^{ᵢ} is the down projection matrix, and dᵢ is the intermediate size which is typically four-fold of the hidden size: dᵢ=4 d. The intermediate variables Z, Z′∈ [symbol] ^{d}^{ᵢ}^{×l} are auxiliary factors to be optimized. Specifically, some embodiments consider minimizing the decoupled loss:

[symbol]

₄=α∥Wᵤ−Z∥²+β∥Z′−σ(Z)∥²+γ∥W_{d}Z′−Y∥², (23)

for auxiliary variables Z and Z′, given calibration input X and output Y. The optimal Z′, in embodiments, is alternatingly obtained given other parameters fixed:

$${Z}^{′} = {( γ {W}_{d}^{T} {W}_{d} + β I )}^{+} ( β σ ( Z ) + γ {W}_{d}^{T} Y ) . \qquad ( 24 )$$

Optimal Z, in embodiments, is also obtained in a closed-form way for the case of ReLU:

Z₋=WᵤX, (25)

$${Z}_{+} = \frac{1}{α + β} ( α {Z}_{-} + β {Z}^{′} ) , \qquad ( 26 )$$

depending on Z's element-wise sign. For other nonlinear activation functions, the optimal Z is modified accordingly.

This approach, in embodiments, is used for low-rank approximation, pruning, and quantization. For example, given Z, some embodiments optimize the low-rank matrix

$${\hat{W}}_{u} = {B}_{u} {A}_{u} by SVD of {ZX}^{+} {C}^{\frac{1}{2}} ,$$

where ZX⁺ corresponds to the effective weight matrix to map X onto Z. Given Z′, some embodiments approximate

$${\hat{W}}_{d} = {B}_{d} {A}_{d} by SVD of {YZ}^{′ +} {C}_{d}^{\frac{1}{2}} ,$$

given correlation C_{d}=Z′Z′^{T}. This alternating solution does not require gradient calculations, but it is iterated over a few rounds. Some embodiments integrated the rank reduction with pruning and quantization in a similar manner.

### Exemplar LLM/VLM Compression

Some benchmark results validate the compression capabilities of the present disclosure across various model sizes in comparison to baseline methods. For example, the perplexity results of the original un-compressed LLM models for Wikitext-2 benchmark are: 27.7 and 12.5 for OPT-125M and OPT-2.7B models. When compressing 10% with the plain SVD, it degrades to: 393.8 and 1922.0. With the joint compression having the best pre-conditioning and junction matrices, the perplexity is significantly improved to: 29.0 and 12.3. Here, some embodiments used just 4 iterations for joint UD compression and 8 iterations for joint QK compression, and only 32 calibration data from the C4 dataset are used to calculate the pre-conditioning matrix. It was also found that the diagonal Hessian is worse than the diagonal [symbol] ₂-norm, whereas covariance pre-conditioning can be terrible in low compression regimes for larger LLMs. In contrast, the superiority of root covariance is remarkable. More importantly, the choice of junction matrix enabling block identity transform is considerably beneficial to compress LLMs. The methods in some embodiments also achieve slightly better performance than the original un-compressed LLMs for a few cases because of the calibration benefit. In addition, some embodiments confirm that the required number of floating operations and multiply-accumulate operations can be reduced with the latent dimension.

Another validation of VLM compression for the ScienceQA benchmark shows the significant benefit of the present disclosure. The accuracy of LLaVA-7B models for the ScienceQA multi-modal reasoning benchmark was 70%. The plain SVD at 20% compression ratio had 0.1% accuracy over different subjects, while the method in the present disclosure improves to 63.9% accuracy. It is verified that latent representation of AI models significantly outperforms other low-rank compression methods across diverse reasoning problems over different subjects/contexts/grades, approaching the performance of the original un-compressed LLaVA model.

### OTHER EMBODIMENTS

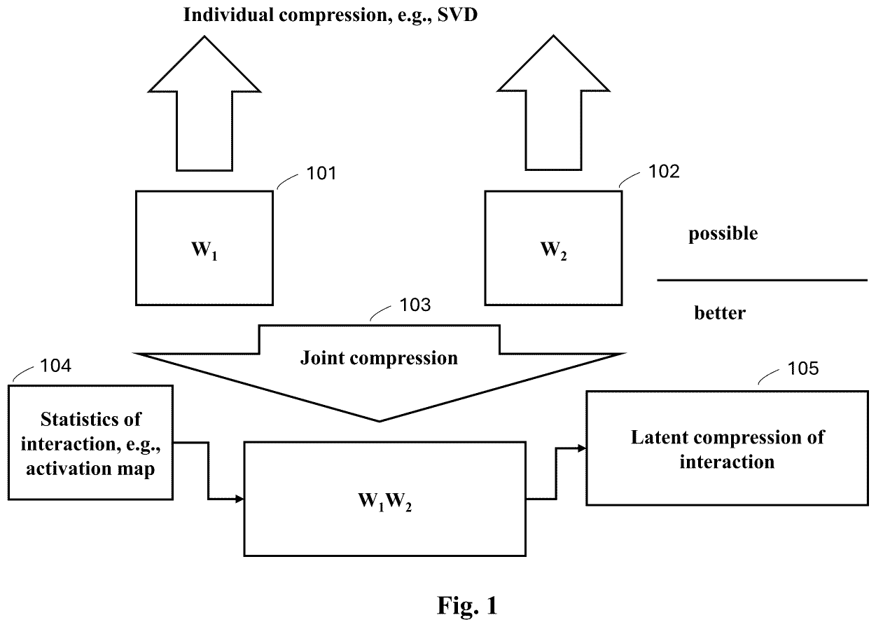

FIG. 1 is a block diagram illustrating an example architecture of a neural network model comprising functionally coupled modules that interact using a compressed representation in a latent space. More specifically, a first module associated with a first weight matrix 101 W₁ and a second module associated with a second weight matrix 102 W₂, wherein the first module is functionally coupled to the second module, and wherein the first and second modules are collectively configured to transform the input data into output data based on an interaction between the first and second weight matrices. The individual compression paths, e.g., via singular value decomposition (SVD), shown above each module illustrate that isolated compression of each matrix is possible but may not yield optimal performance. By contrast, joint compression 103 leverages shared structure and statistical dependencies across the two matrices.

The joint compression 103 in FIG. 1 uses the statistics of the interactions 104 between these two modules to guide the latent compression of the interaction 105 of the two weight matrices. These statistics may include activation maps, attention weights, or covariance matrices derived from calibration data. For example, the interactions between the two modules, in embodiments, are the dot product between Query and Key in the attention mechanism. The modules can be in various models, such as large language models (LLMs), large vision-language models (LVLMs), masked language models (MLMs), vision transformers (ViTs), denoising diffusion models, etc.

The resulting latent compression of the interaction 105 operates directly in the latent space and enables efficient inference by replacing the original full-rank interaction, reducing parameter count and computational overhead without significantly degrading performance.

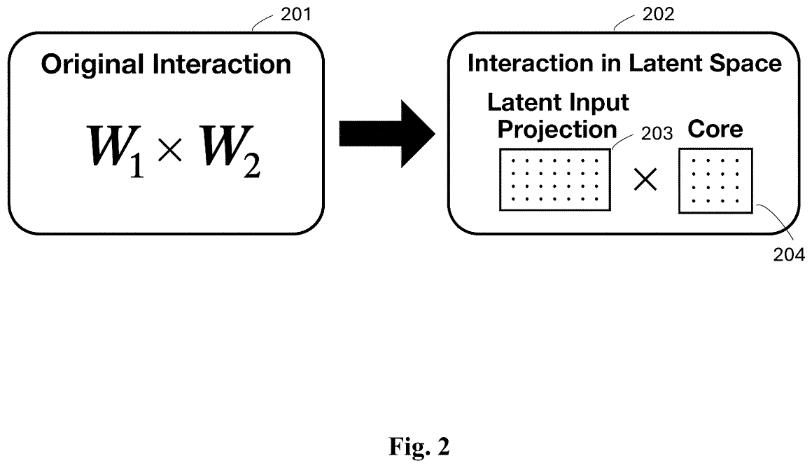

FIG. 2 is a schematic diagram showing the transition from a full-rank interaction 201 between two weight matrices to a compressed interaction 202 performed via a latent input projection matrix 203 and a core matrix 204 or tensor. More specifically, the original interaction, denoted by the operation W1×W2, represents a full-rank transformation that may be found in standard neural network layers, such as attention mechanisms or multi-layer perceptrons.

To improve computational efficiency and reduce memory requirements, the original interaction is replaced by the compressed interaction 202 in a reduced-dimensional latent space. In this configuration, the input is first projected into a latent space using a latent input projection matrix 203 and then processed via a core matrix 204 or tensor, which encodes the interaction logic in the latent domain. The core matrix 204, in embodiments, takes the form of a matrix, tensor, or structured operator derived from tensor decomposition techniques such as Tucker, canonical polyadic (CP) decomposition, or SVD.

This latent-space interaction approximates the functional behavior of the original W1×W2 operation while operating with significantly fewer parameters and lower computational cost. Because the latent representation captures dominant modes of variation or statistically significant correlations between the original matrices, the approximation maintains fidelity in practice, particularly when derived using activation-aware statistics or calibration data. The approach may be applicable to various neural network architectures, including transformer blocks, encoder-decoder models, and deep MLP stacks.

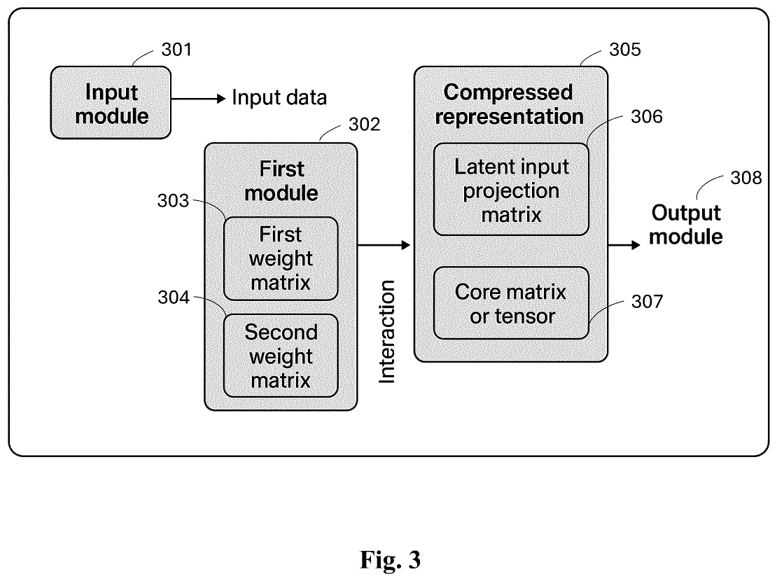

FIG. 3 is a flow diagram illustrating a method for generating a compressed representation of an interaction between weight matrices, including projection into a latent space and execution of the interaction using latent components.

An input module 301 receives input data, which is supplied to a first module 302. The first module 302 includes a first weight matrix 303 and a second weight matrix 304, which together define a functional interaction. This interaction represents, for example, the transformation between input and output feature spaces in a neural network, such as a dot-product between query and key projections in an attention mechanism or an up/down projection in a multi-layer perceptron (MLP) layer.

Rather than executing the interaction directly using full-rank weight matrices 303 and 304, the system, in embodiments, applies a compressed representation 305. This compressed representation 305 includes a latent input projection matrix 306, which projects the input data into a reduced-dimensional latent space, and a core matrix or tensor 307, which performs a transformation within that latent space to approximate the original interaction.

The result of the compressed interaction is then provided to an output module 308, which outputs transformed data for subsequent processing within the neural network. This approach enables the efficient execution of complex neural operations while preserving essential functional characteristics. The compression strategy typically relies on statistical information or decomposition techniques such as Tucker decomposition, SVD, or CP decomposition, as described in FIGS. 1 and 2. The architecture is compatible with transformer-based models, large language models (LLMs), vision transformers (ViTs), and similar AI systems.

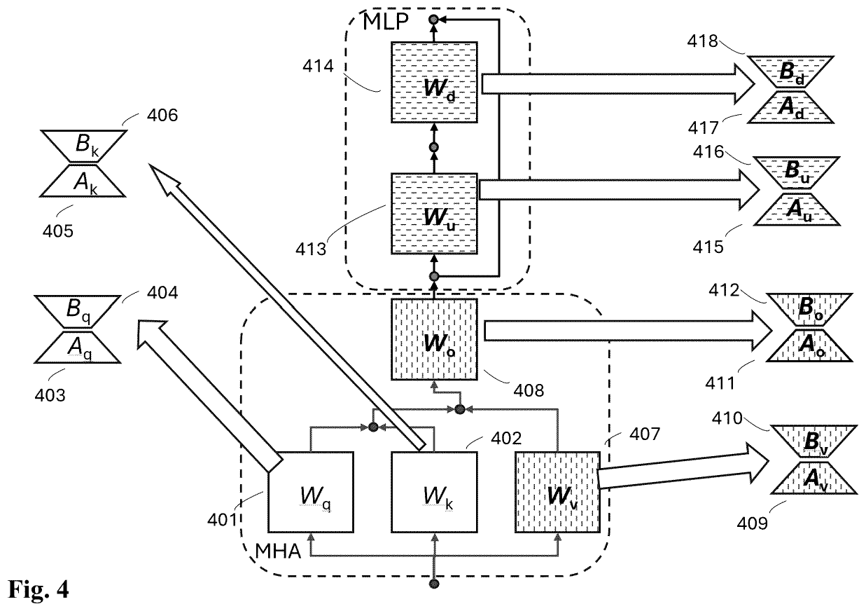

FIG. 4 is a diagram illustrating an example attention mechanism using the disclosed compressed representation to approximate module interactions. The figure demonstrates how different projections within a transformer-based neural network model are jointly compressed using latent-space approximations in accordance with some embodiments. In this embodiment, the compression uses uniform or fixed-rank approximations across modules. However adaptive or nonuniform-rank strategies may also be utilized in some embodiments.

A query-projection module 401, associated with a weight matrix W_{q} and a key-projection module 402, associated with a weight matrix Wₖ, form part of a multi-head attention (MHA) mechanism. These modules interact via a dot-product operation to generate attention maps. To reduce complexity, the query projection module 401 is approximated using a pair of low-rank matrices A_{q} and B_{q}, shown in blocks 403 and 404, respectively. Similarly, the key projection module 402 is approximated using low-rank matrices Aₖ and Bₖ, shown in blocks 405 and 406.

The value projection module 407, with weight matrix Wᵥ, and the output projection module 408, with weight matrix Wₒ, are also compressed. The value projection module 407 is approximated by low-rank matrices Aᵥ, and Bᵥ, (blocks 409 and 410), and the output projection module 408 is approximated by Aₒ and Bₒ (blocks 411 and 412), respectively.

Beyond the attention components, the diagram also illustrates compression of a multi-layer perceptron (MLP) substructure. The up-projection module 413 (with weight Wᵤ) and the down-projection module 414 (with weight W_{d}) are approximated via respective low-rank matrix pairs: Aᵤ and Bᵤ (blocks 415 and 416) for the up-projection, and Aa and Ba (blocks 417 and 418) for the down-projection.

This comprehensive LLM joint tensor compression framework leverages shared statistical structure across these layers to enable efficient and accurate approximations. The compressed modules, in some embodiments, are derived using joint tensor decompositions, such as Tucker decomposition or alternating SVD, optionally guided by activation statistics. The approach generalizes across attention mechanisms and feedforward blocks and may be suitable for large transformer-based architectures including LLMs, vision-language models, and diffusion models.

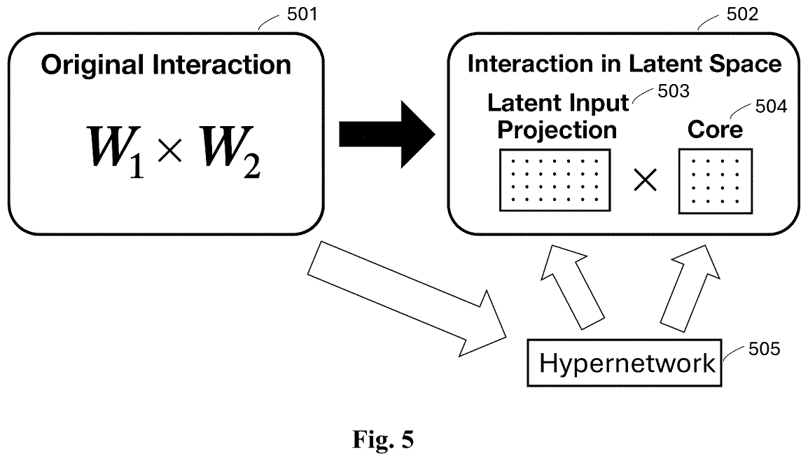

FIG. 5 is a diagram depicting a variation in which a hypernetwork 505 generates one or more components of a compressed representation used to approximate a full-rank interaction between neural network modules.

As shown, an original interaction 501 between a first weight matrix W₁ and a second weight matrix W₂ is represented by the operation W₁×W₂. Rather than executing this high-dimensional interaction directly, the system employs a latent-space interaction 502 that includes a latent input projection matrix 503 and a core matrix or tensor 504, which together define a compressed, low-dimensional approximation of the original transformation.

In this variation, the hypernetwork 505 is configured to generate at least one of the latent input projection matrix 503 or the core matrix or tensor 504. The hypernetwork 505 operates on a lower-dimensional latent parameter vector, and outputs the full matrices used for compression. This approach enables the model to dynamically generate compressed representations conditioned on context, task, or learned embeddings, further reducing storage and parameter redundancy.

The use of hypernetworks to produce components of a latent compression pipeline provides improved flexibility and generalization, and is particularly advantageous in meta-learning or continual learning settings. The approach is compatible with both static and adaptive compression strategies, and, in some embodiments, is combined with other decomposition-based techniques as described in connection with FIGS. 1-4.

In some embodiments, a hypernetwork is trained on pairs of original weight matrices and associated latent parameters, minimizing a loss function that penalizes deviation between the generated weight values and target low-rank decompositions, e.g., using mean squared error across a validation set of module activations.

Alternatively, in some embodiments a hypernetwork is implemented as a feedforward neural network comprising three fully connected layers, each followed by ReLU activations, taking as input a latent parameter vector of dimension d_{z} and outputting a vectorized form of the weight matrix.

FIG. 6 is a diagram illustrating an example of joint compression of a multi-head query-projection matrix and key-projection matrix in an attention mechanism. The diagram shows how shared compression is achieved by leveraging statistics across all heads in a multi-head attention (MHA) layer.

In this example, a query-projection matrix Wq and key-projection matrix Wₖ are each composed of h head-specific projections. The query matrix W_{q} is shown as a collection of head-specific matrices W_{q,1} through W_{q,h} (blocks 601 and 602), each having shape (dₕ, d), where dₕ is the dimensionality per head and d is the input dimensionality. Similarly, the key matrix Wₖ includes matrices W_{k,1} through W_{k,h} (blocks 603 and 604), each of shape (dₕ, d).

Each head performs a dot-product operation between its query and key projections, generating head-specific statistics. These interactions are aggregated into a tensor G (block 605) of shape (h, d, d), formed via the Einstein summation expression: G=einsum(“hij,hik→hjk”, W_{q}, Wₖ)

The tensor G is decomposed via Tucker decomposition (block 606), which yields low-rank projection matrices for compression. Specifically:
A query projection matrix A_{q} (block 607) with shape (r_{q}, d)
A key projection matrix Aₖ (block 608) with shape (rₖ, d)
A shared core tensor H (block 609) with shape (h, r_{q}, rₖ)

These components are then used to reconstruct approximated projection matrices as:

$${B}_{q} = {W}_{q} \times {A}_{q}^{T}$$

$${B}_{k} = {W}_{k} \times {A}_{k}^{T}$$

This framework allows joint low-rank compression of all query-key interactions across multiple heads, enabling both parameter reduction and retention of key structural correlations between heads. Such joint compression is more effective than treating each head independently and enables fine-grained control over compression ranks r_{q} and rₖ. The approach may be suited for large transformer models where multi-head attention dominates model capacity.

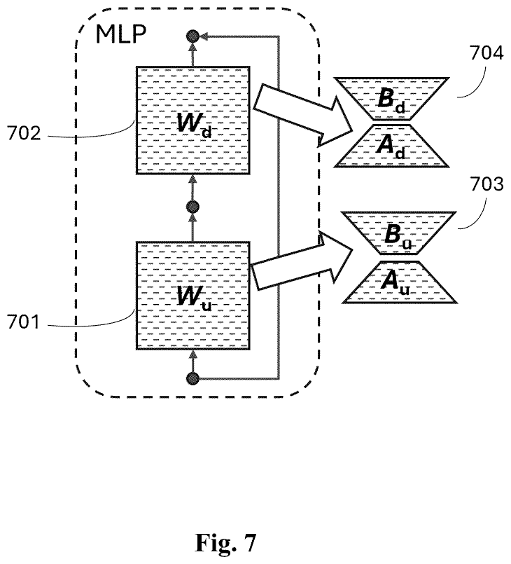

FIG. 7 shows a diagram illustrating an example latent MLP using the disclosed compressed representation to approximate standard MLP (multi-layer perceptron) layers in a neural network.

As shown, the architecture includes two weight matrices: an up-projection weight matrix Wᵤ (block 701) and a down-projection weight matrix W_{d} (block 702), which are commonly used in transformer-based MLP blocks. These matrices transform input representations to a higher-dimensional space (via Wᵤ) and then reduce them back to the original size (via W_{d}), typically surrounding a nonlinearity such as GELU or ReLU.

In this compressed architecture, the matrices Wᵤ (block 701) and W_{d} (block 702) are approximated using low-rank latent projections:
The up-projection matrix Wᵤ is factorized into two matrices: Aᵤ and Bᵤ, where

$$( block 703 ) {B}_{u} = {W}_{u} \times {A}_{u}^{T}$$

Similarly, the down-projection matrix W_{d} is approximated using A_{d} and B_{d}, where

$$( block 704 ) {B}_{d} = {W}_{d} \times {A}_{d}^{T}$$

This latent factorization reduces the number of parameters and the computational cost of the forward pass, while maintaining the functional behavior of the original full-rank MLP layer. The design aligns with the broader framework described in connection with FIGS. 1-6, where latent-space approximations are applied to compress interactions between modules.

The latent MLP architecture of FIG. 7, in some embodiments, is implemented using decomposition methods (e.g., SVD or Tucker), or generated by hypernetworks based on contextual parameters or training history. This approach is effective in transformer models where MLP layers contribute significantly to model size and inference cost.

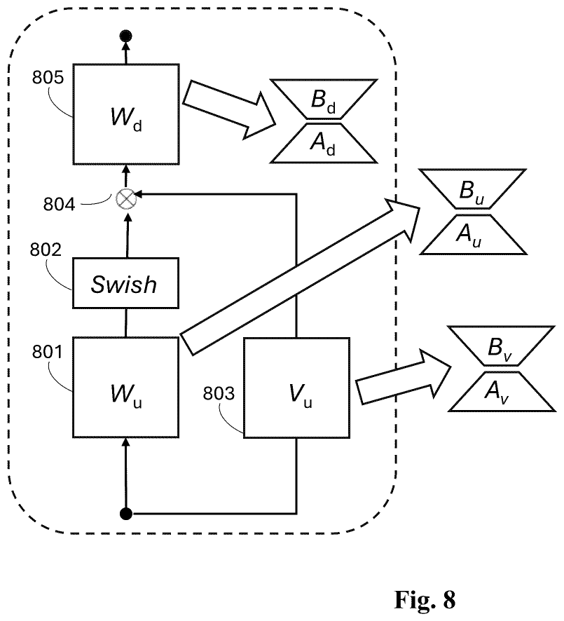

FIG. 8 is a diagram illustrating an example Latent SwiGLU architecture that uses the disclosed compressed representation to approximate a SwiGLU layer in a neural network model.

The SwiGLU activation mechanism includes two parallel projection branches. One branch passes the input through an up-projection matrix Wᵤ 801, followed by a Swish activation function 802, while the other branch processes the same input through a second matrix Vᵤ 803. The outputs of these two branches are then combined via elementwise multiplication 804 (Hadamard product ⊗) and passed to a down-projection matrix W_{d} 805 to produce the final output of the layer.

To reduce the parameter count and computational complexity of this layer, each of the full-rank weight matrices is approximated using low-rank latent factorization:
The up-projection matrix Wᵤ is approximated by a pair of matrices Aᵤ and Bᵤ, such that

$${B}_{u} = {W}_{u} \times {A}_{u}^{T}$$

The parallel projection matrix Vᵤ is approximated by Aᵥ and Bᵥ, such that

$${B}_{v} = {V}_{u} \times {A}_{v}^{T}$$

The down-projection matrix W_{d} is approximated by A_{d} and B_{d}, where

$${B}_{d} = {W}_{d} \times {A}_{d}^{T}$$

These low-rank approximations are shown in the diagram with Aᵤ/Bᵤ, Aᵥ/Bᵥ, and A_{d}/B_{d} to the right of their respective original matrices.

This compressed SwiGLU structure enables efficient approximation of the original layer with a significantly smaller number of trainable parameters and operations, especially valuable in large-scale transformer models. The latent components may be determined via joint tensor decomposition, activation-aware SVD, or learned via auxiliary networks such as hypernetworks. The design is compatible with standard or variant SwiGLU activations and can integrate seamlessly into a feedforward block of transformer-based networks.

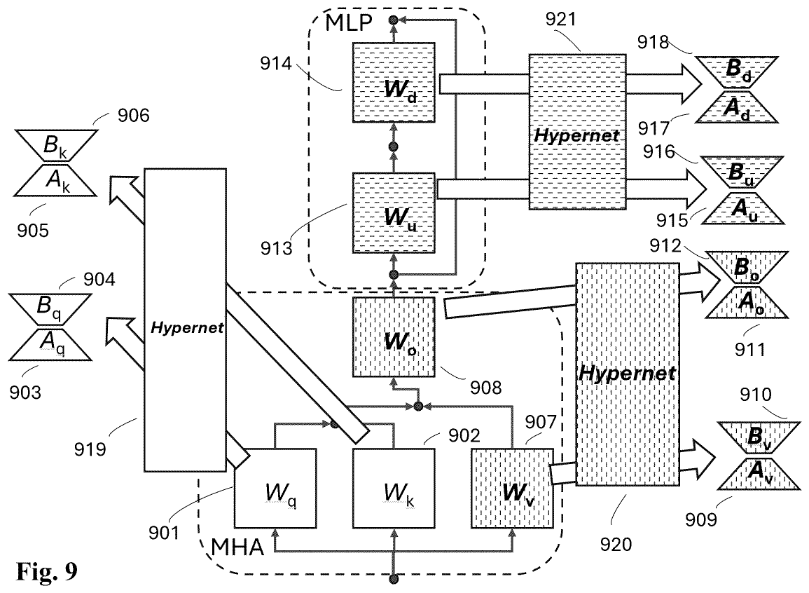

FIG. 9 is a diagram illustrating an example of using hypernetworks to generate compressed representations for neural network modules within a joint tensor compression framework.

A query-projection module 901, associated with weight matrix W_{q}, and key-projection module 902, associated with weight matrix Wₖ, form part of a multi-head attention (MHA) block. These matrices interact via dot-product attention and are approximated by low-rank latent decompositions. The query projection module 901 is approximated by matrices A_{q} and B_{q} (blocks 903-904), while the key projection module 902 is approximated by matrices Aₖ and Bₖ (blocks 905-906). Both sets of low-rank factors are jointly generated by a hypernetwork 919, which outputs latent parameters or compressed weights.

A value projection module 907 (weight Wy) and an output projection module 908 (weight Wₒ) are similarly compressed. The value projection is approximated by matrices Aᵥ and Bᵥ (blocks 909-910), and the output projection by matrices Aₒ and Bₒ (blocks 911-912). These four matrices are jointly generated by a second hypernetwork 920, allowing coordinated compression across the attention output path.

In the feedforward path, an up-projection module 913 (weight Wᵤ) and a down-projection module 914 (weight Wd) form the MLP layer. These are also approximated using low-rank decompositions: Aᵤ and Bᵤ (blocks 915-916) for Wᵤ, and A_{d} and B_{d} (blocks 917-918) for W_{d}. These matrices are jointly produced by a third hypernetwork 921.

Together, the figure illustrates how a full transformer block, including both attention and MLP substructures, are compressed using hypernet-generated latent components instead of fixed decompositions. Each hypernetwork (919, 920, 921) is trained to generate the appropriate projection factors on the fly, conditioned on task, layer index, or input context. This provides flexibility and parameter efficiency, especially in large language models (LLMs) or adaptable architectures.

The use of hypernetworks here allows dynamic, data-driven generation of compression weights, reducing redundancy and improving generalization. It also aligns with modular deployment strategies for scalable AI systems.

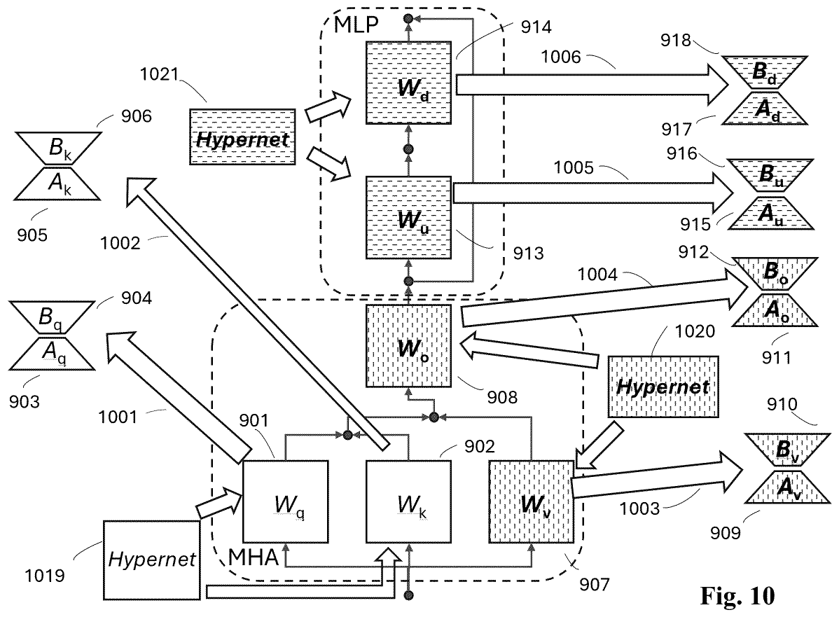

FIG. 10 is a diagram illustrating an example of disclosed compressed representations where there are nonlinear operations (blocks 1001-1006) between low-rank matrices. The nonlinear operations are one or more of various activation functions, neural networks, square functions, and other nonlinear functions.

A query-projection module 901 and key-projection module 902 operate in a multi-head attention (MHA) configuration. The query matrix W_{q} and key matrix Wₖ are each approximated by low-rank matrices A_{q}/B_{q} (blocks 903-904) and Aₖ/Bₖ (blocks 905-906), respectively. Unlike earlier examples, the low-rank factor outputs are processed through nonlinear modules 1001 and 1002 before being combined. The resulting representations are dynamically refined and better adapted to task-specific nonlinearity. These low-rank matrices are jointly generated by a hypernetwork 1019.

Similarly, the value projection module 907 and output projection module 908 are approximated by Aᵥ/Bᵥ (blocks 909-910) and Aₒ/Bₒ (blocks 911-912), respectively. Again, nonlinear blocks 1003 and 1004 are inserted between the low-rank components, allowing richer approximations beyond linear compression. These outputs are jointly generated and modulated by a hypernetwork 1020.

In the MLP substructure, the up-projection module 913 and down-projection module 914 (weights Wᵤ and W_{d}) are compressed via latent matrices Aᵤ/Bᵤ (blocks 915-916) and A_{d}/B_{d} (blocks 917-918), with nonlinearities (blocks 1005 and 1006) inserted between projection stages. A hypernetwork 1021 is used to generate these components and may dynamically adapt the nonlinearities as well.

This architecture enables compression that goes beyond linear latent approximation. The inclusion of nonlinear operations between projection stages allows for enhanced representational power, increased expressivity, and finer control over network behavior, making the approach especially suitable for compressing large-scale models like LLMs and vision transformers while retaining high functional fidelity.

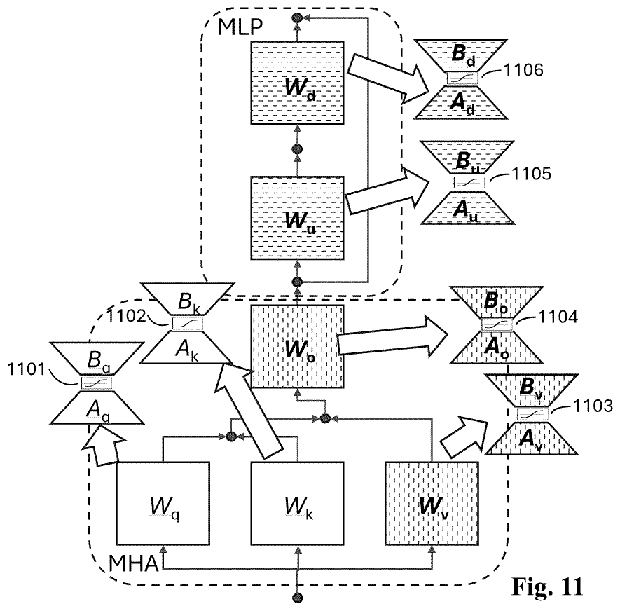

FIG. 11 is a diagram illustrating an example of disclosed compressed representations where the low-rank matrices are further quantized. Two implementations are shown: a first approach involves deriving compressed representations and then applying quantization post-compression, while a second approach involves performing compression and quantization simultaneously.

In the multi-head attention (MHA) block, the query matrix W_{q} and key matrix Wₖ are each decomposed into low-rank pairs: A_{q}, B_{q} (block 1101) and Aₖ, Bₖ (block 1102), respectively. These decompositions approximate dot-product interactions as in prior figures. The value projection Wᵥ is approximated by Aᵥ, Bᵥ (block 1103), and the output projection Wₒ is approximated by Aₒ, Bₒ (block 1104).

In the MLP layer, the up-projection matrix Wᵤ and down-projection matrix W_{d} are approximated by Aᵤ, Bᵤ (block 1105) and A_{d}, B_{d} (block 1106), respectively.

Each low-rank matrix pair in the figure represents a compressed form that is then subjected to quantization. This may include uniform quantization, learned codebooks, or matrix factorization with quantized components. In some cases, such as the path from Wᵥ to Aᵥ/Bᵥ, compression and quantization may be fused into a single pipeline, reducing latency and hardware complexity.

This figure supports techniques where compression is not limited to dimensionality reduction but may also extend to numerical precision reduction, thereby achieving both model size and computational gains. The integration of quantization into the low-rank factorization process also enables better co-optimization of approximation error and storage efficiency.

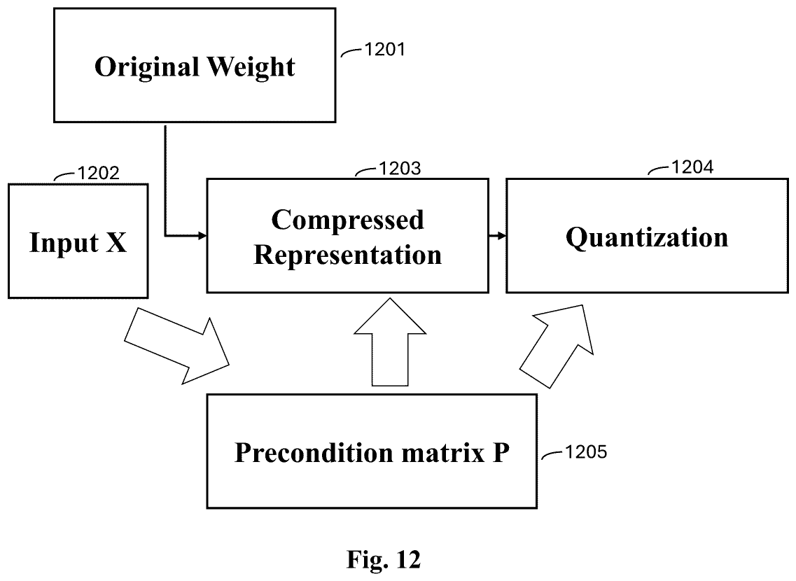

FIG. 12 is a diagram illustrating an example of disclosed compressed representations where the low-rank matrices are further pruned/sparsified. The figure depicts a sequential compression and quantization pipeline, where a preconditioning matrix is used to enhance compression quality.

An original weight matrix 1201 and input data 1202 are processed to generate a compressed representation 1203, which is then passed to a quantization stage 1204. A precondition matrix P 1205 is used to improve both the compression and quantization steps. The preconditioning, in some embodiments, is derived from activation statistics, Hessian approximations, or optimization-aware heuristics.

Two main implementations are supported:
1. Derive the compressed representation 1203 first, then prune or quantize it in 1204.
2. Jointly perform compression and pruning/quantization during a single optimization procedure.

For example, quantization uses the preconditioning matrix 1205 to apply iterative rounding projections, improving numerical stability and model accuracy. In the context of pruning, iterative hard-thresholding is used to incrementally zero out small-magnitude components, improving sparsity without significantly degrading performance. Some embodiments initialize the optimization with structure-aware priors or progressive sparsity schedules.

A progressive compression strategy iteratively reduces rank, prune connections, and quantize weights in stages, dynamically adjusting thresholds or ranks per iteration. This multi-stage approach allows compression ratios to increase over time while minimizing performance degradation, and typically yield substantial gains in both model size and computational efficiency, particularly when targeting edge deployment or low-power inference.

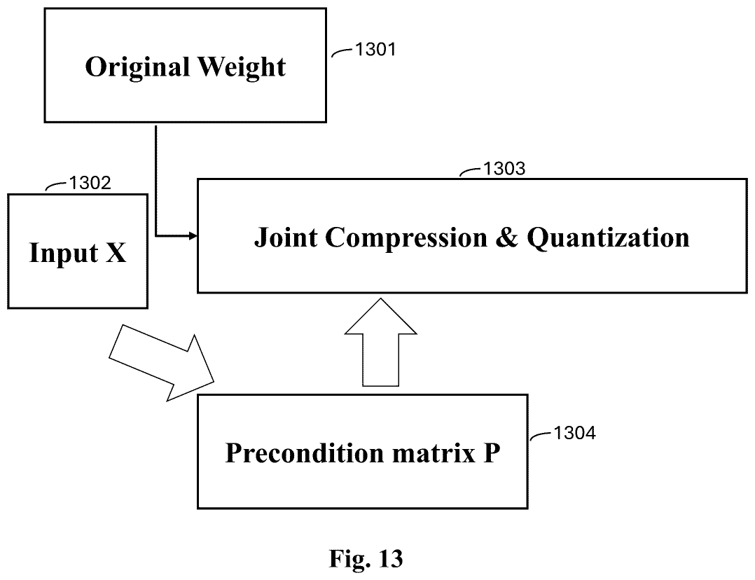

FIG. 13 is a diagram illustrating an example of disclosed compressed representations where the ranks of the low-rank matrices are adaptive/nonuniform for different components. The diagram illustrates a joint compression and quantization pipeline that integrates preconditioning to improve the adaptive compression.

An original weight matrix 1301 and input data 1302 are processed together by a joint compression and quantization module 1303, which produces compressed and quantized parameters directly in a single step. This operation is guided by a precondition matrix P 1304, which adjusts the compression strategy for different parts of the network.

In this implementation, the rank of the low-rank factor A_{q} used for the query projection, in some embodiments, differs from the rank of Aᵥ used in the value projection, and from the rank of Aᵤ used in the MLP up-projection. These ranks, in some embodiments, are set using heuristic rules, derived from activation statistics, or optimized using validation performance.

By applying different ranks per component, the model allocates more capacity where needed (e.g., attention blocks) and applies stronger compression where the sensitivity is lower (e.g., down projections). The precondition matrix P 1304 allows this rank allocation to be coordinated with quantization-aware optimization, further improving efficiency.

This figure supports adaptive, joint strategies where compression granularity is not uniform across layers, allowing better control over the tradeoff between accuracy and model size.

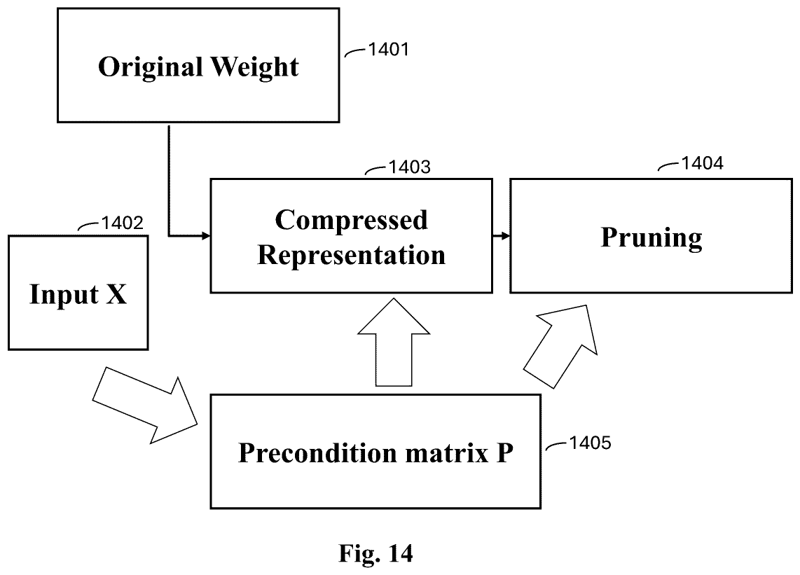

FIG. 14 is a diagram illustrating sequential low-rank compression and pruning, according to some embodiments of the present disclosure.

An original weight matrix 1401 and input data 1402 are supplied to a compression module 1403, which generates a compressed representation of the original weight. This representation is then forwarded to a pruning module 1404, which eliminates less significant parameters based on magnitude, gradient sensitivity, or learned sparsity patterns.

The process is guided by a precondition matrix P 1405, which is used to rescale or transform the original weight matrix or intermediate representation to improve the numerical stability and efficiency of the compression and pruning steps. For example, the precondition matrix is derived from second-order information such as the Fisher Information Matrix or a low-rank approximation of the Hessian.

While the figure shows the pruning and compression steps performed sequentially, some embodiments fuse these into a joint optimization. The representation 1403, in some embodiments, corresponds to a core tensor in the Tucker decomposition, with low-rank projection matrices applied along one or more tensor modes.

This structure enables Tucker decomposition to be combined with structured pruning techniques (e.g., channel pruning, group sparsity) while preserving decomposability. The combined use of compression, preconditioning, and pruning allows for high compression ratios while maintaining performance in deep neural networks, particularly transformer-based architectures.

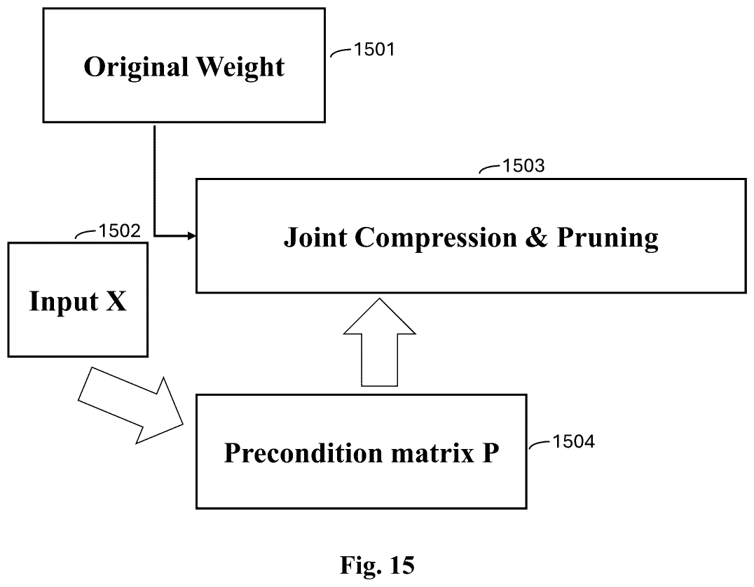

FIG. 15 is a flow diagram illustrating joint low-rank compression and pruning, according to some embodiments of the present disclosure.

An original weight matrix 1501 and input data 1502 are processed together in a joint compression and pruning module 1503, which applies to both low-rank approximation and structural sparsification. This process is informed by a precondition matrix P 1504, which, in some embodiments, adjusts the decomposition strategy based on data-driven statistics.

The precondition matrix 1504, in some embodiments, is derived from covariance matrices, second-order gradients, or empirical activation distributions of the input data 1502. These statistics are used to bias the decomposition toward directions that preserve variance or sensitivity, allowing better functional retention after compression and pruning.

Unlike sequential approaches, the joint compression and pruning module 1503 performs compression and pruning in a coupled manner, for example via a sparsity-aware low-rank factorization or structured Tucker decomposition with thresholded core tensor components. The precondition matrix 1504 also regularize this process, penalizing directions of low statistical energy or applying scaling to normalize gradient propagation.

This strategy enables compression pipelines that are more robust to performance loss, particularly in networks with heterogeneous input distributions or fine-tuned downstream tasks. It also facilitates dynamic adjustment of compression strength based on run-time data profiles.

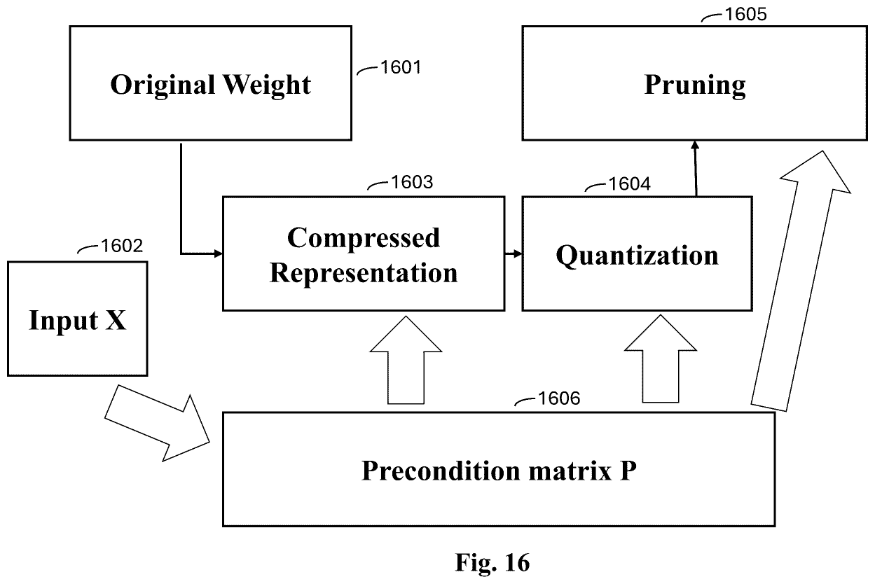

FIG. 16 is a diagram illustrating an example of sequential low-rank compression, quantization, and pruning, according to some embodiments of the present disclosure.

An original weight matrix 1601 and input activation 1602 are processed to produce a compressed representation 1603, which captures the low-rank approximation of the original parameter space. This stage is influenced by a precondition matrix P 1606, which adjusts the compression dynamics based on statistical or structural properties of the input and weights, for example, by modulating the scaling, rotation, or axis selection in the decomposition.

The resulting compressed representation 1603 is then passed to a quantization module 1604, which performs precision reduction (e.g., via uniform rounding, codebooks, or learned quantization mappings) to minimize storage and computation overhead.

Finally, the quantized weights are subjected to a pruning operation 1605, which removes redundant or insignificant parameters to enforce sparsity. The pruning may be structured (e.g., channel-level) or unstructured, and may involve techniques such as magnitude thresholding, sensitivity-based removal, or iterative hard thresholding.

This pipeline enables high-ratio model compression while preserving model fidelity and minimizing performance degradation. The preconditioning matrix 1606 plays a role in ensuring numerical robustness across stages by compensating for distortion introduced at each transformation step.

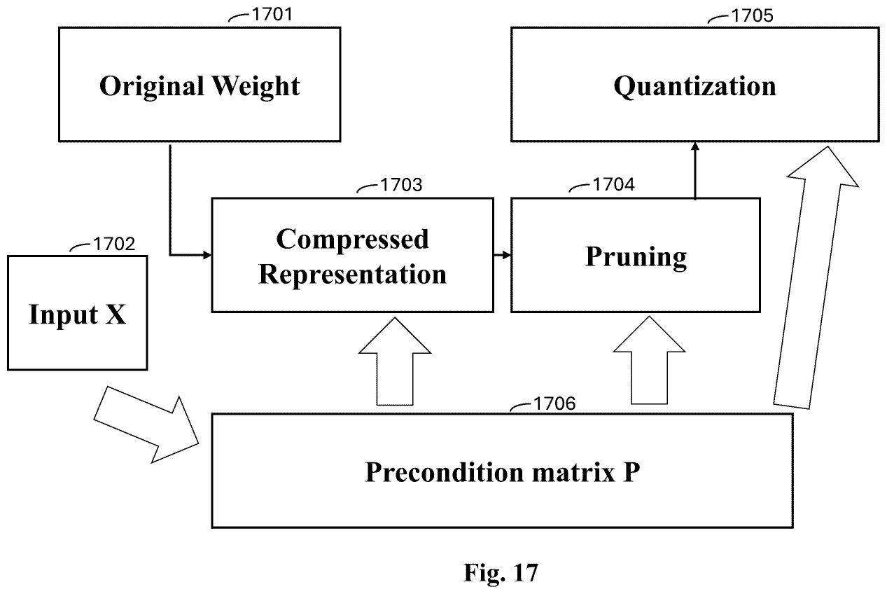

FIG. 17 is a diagram illustrating an example of sequential low-rank compression, pruning, and quantization, according to some embodiments of the present disclosure. An original weight matrix 1701 and input activation 1702 are fed into a compression module 1703, which generates a compressed representation of the original weight matrix under guidance from a precondition matrix P 1706.

The compressed representation 1703 is then processed by a pruning module 1704, which applies sparsification techniques—such as thresholding, norm-based elimination, or importance scoring—to reduce the number of active parameters. Following pruning, the surviving elements are passed into a quantization module 1705, where their precision is reduced to minimize memory and bandwidth usage (e.g., via 8-bit fixed-point or codebook-based quantization). This specific sequence of compression→pruning→quantization enables fine-grained structural optimization followed by compact representation, allowing for high-efficiency deployment in constrained hardware environments. The precondition matrix 1706 helps adapt the compression process to input distributions or layer-specific dynamics, improving the preservation of model accuracy post-compression.

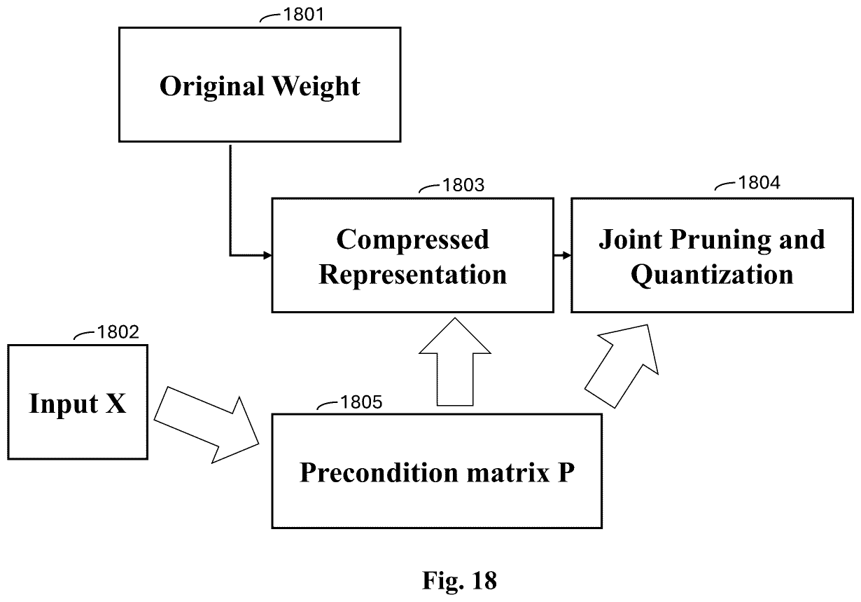

FIG. 18 is a diagram illustrating an example of sequential low-rank compression followed by joint pruning and quantization, according to some embodiments of the present disclosure.

An original weight matrix 1801 and input activation 1802 are provided to a compression module, which generates a compressed representation 1803 of the weights by applying a low-rank approximation, informed by a precondition matrix P 1805. The preconditioner adjusts the structure of the compression to account for input distribution, numerical stability, or optimization constraints.

The resulting compressed representation 1803 is then passed into a joint pruning and quantization module 1804, which performs both structural sparsification and numerical precision reduction in a coupled fashion. This joint treatment enables co-optimization of sparsity patterns and quantization bins, reducing the need for separate optimization stages and yielding better trade-offs in model size and accuracy.

This structure offers advantages in inference efficiency and compression ratio, particularly for deployment in edge or real-time systems where runtime complexity is constrained.

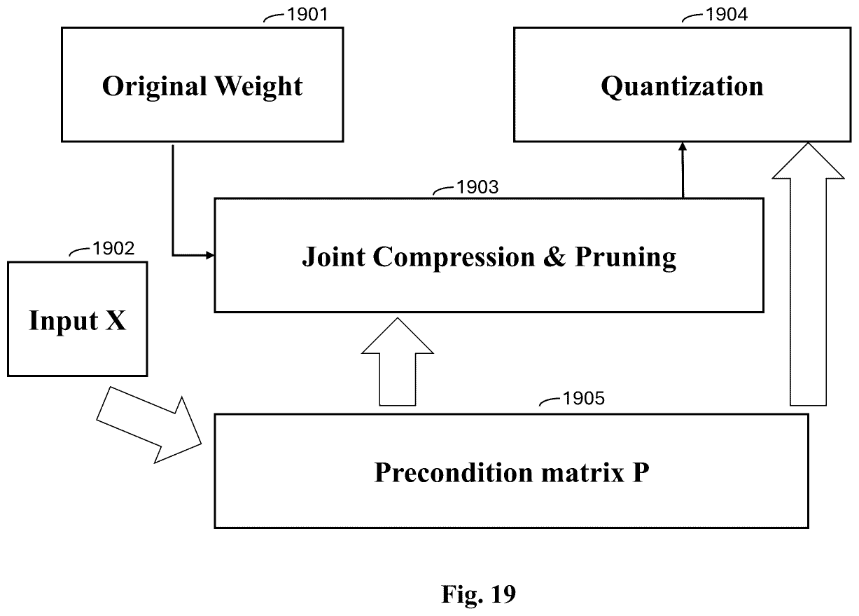

FIG. 19 is a diagram illustrating an example of joint low-rank compression and pruning followed by quantization, according to some embodiments of the present disclosure.

An original weight matrix 1901 and input activation 1902 are provided to a joint compression and pruning module 1903, which performs a unified low-rank decomposition and structured or unstructured pruning operation. This stage is guided by a precondition matrix P 1905, which is derived from activation statistics, optimization metrics, or gradient history, and used to influence the rank selection, pruning thresholds, or alignment of basis functions.

The output of the compression and pruning stage is then passed into a quantization module 1904, which reduces the bit precision of the remaining weights using fixed-point encodings, learned quantization levels, or hardware-specific formats.

This pipeline enables greater compression efficiency by collapsing compression and sparsity enforcement into a single pass, then performing precision reduction afterward. The approach benefits hardware deployment pipelines where quantization is applied late in training or for fine-tuning deployment models.

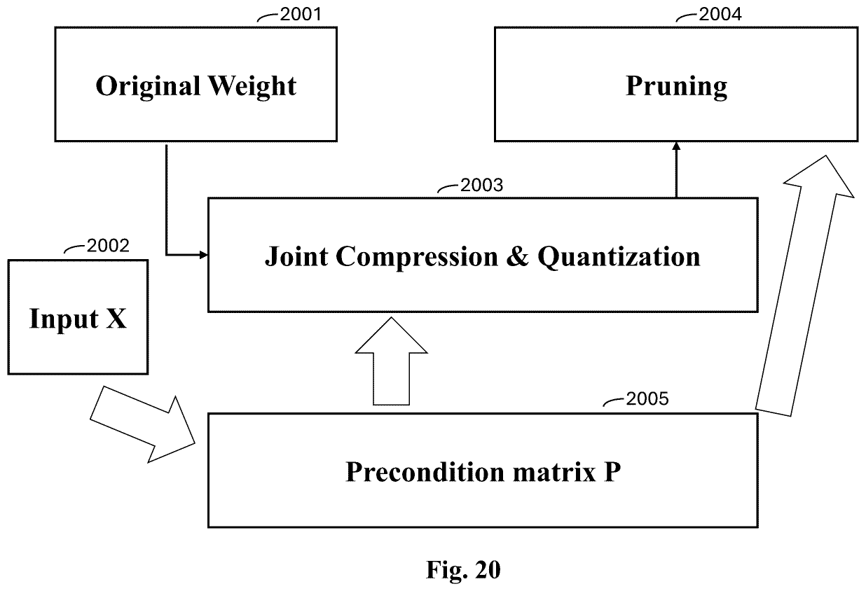

FIG. 20 is a diagram illustrating an example of joint low-rank compression and quantization followed by pruning, according to some embodiments of the present disclosure.

An original weight matrix 2001 and input activation 2002 are processed by a joint compression and quantization module 2003, which simultaneously performs low-rank approximation and weight discretization, using techniques such as matrix factorization with quantized bases or structured low-bit representations. This joint stage is guided by a precondition matrix P 2005, which adjusts the compression rank, quantization scale, or factor initialization based on learned or statistical metrics.

The output of the stage 2003 is then passed to a pruning module 2004, where sparsity is enforced through zeroing out low-magnitude or low-importance weights. This final pruning step allows selective reduction of parameters that are quantized but still redundant or underutilized.

The combination enables efficient front-loaded compression with post-processing to further optimize model size and sparsity, especially useful in deployment scenarios with fixed bit-width accelerators and sparse matrix support.

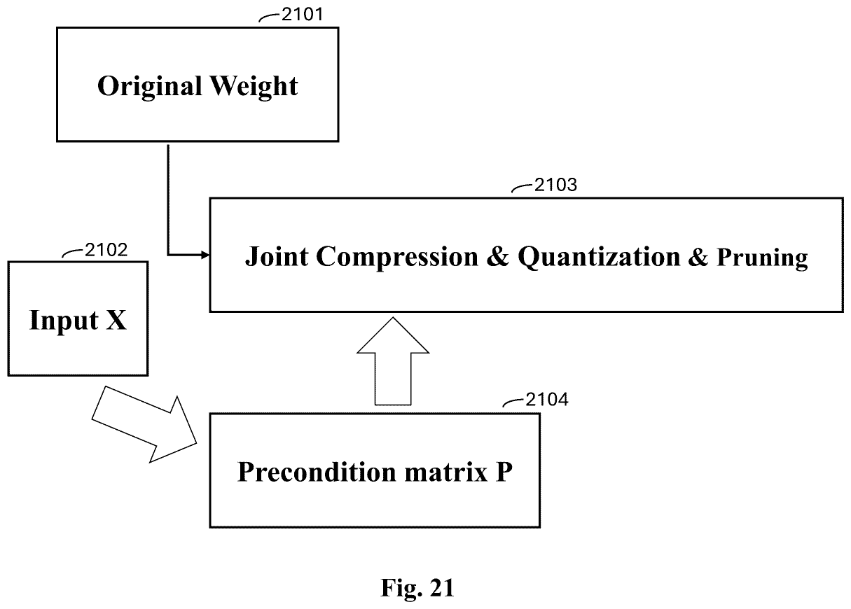

FIG. 21 is a diagram illustrating an example of joint low-rank compression, quantization, and pruning, according to some embodiments of the present disclosure.

An original weight matrix 2101 and input activation 2102 are processed through a unified module 2103 that jointly performs low-rank decomposition, numerical quantization, and sparsity induction. This fully integrated pipeline is guided by a precondition matrix P 2104, which adjusts compression directionality, quantization granularity, and pruning criteria in a coordinated fashion.

This joint operation enables simultaneous co-optimization of all three transformation domains—structure, value resolution, and sparsity—allowing greater synergy than sequential or hybrid approaches. It is suitable for end-to-end differentiable training loops where rank selection, bit allocation, and sparsity targets can be tuned dynamically during optimization.

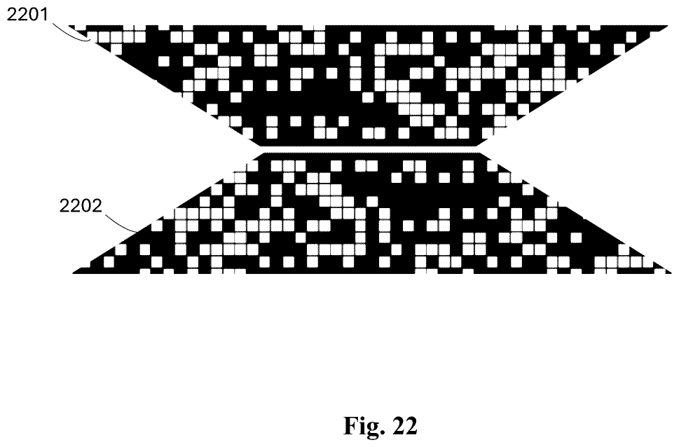

FIG. 22 is a diagram illustrating an example of a pruned latent input projection matrix, according to some embodiments of the present disclosure.

The diagram depicts a structured latent matrix that has undergone pruning, where non-zero elements (white squares 2201) represent retained weights and black regions 2202 represent pruned entries. The pruning can be guided by learned importance scores, sparsity regularization, or iterative hard thresholding.

Such pruned latent matrices, in some embodiments, is used in low-rank attention modules or feedforward layers in neural networks to reduce both computational load and memory footprint while maintaining functional accuracy.

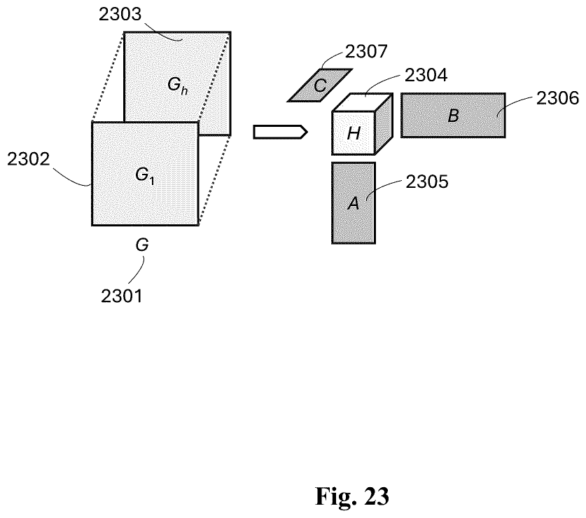

FIG. 23 is a diagram illustrating a Tucker decomposition applied to a joint interaction tensor, according to some embodiments of the present disclosure.

A joint interaction tensor G 2301, which may represent concatenated attention maps, module-wise activations, or cross-layer interactions is shown to include a set of components such as Gₗ and Gₕ (blocks 2302 and 2303), corresponding to individual attention heads or spatial segments.

The tensor G is decomposed into a core tensor H 2304 and three mode-specific projection matrices:
Matrix A 2305,
Matrix B 2306,
Matrix C 2307.

Each matrix transforms a specific mode of the tensor, such as the input channel space, the output channel space, or the head/sequence dimension. This factorization compresses the high-dimensional joint representation while preserving latent structure via multilinear interactions.

The Tucker decomposition enables efficient approximation of large parameter tensors in deep neural networks by identifying shared structure across axes. This form of joint compression is applicable to attention mechanisms, feedforward layers, or inter-block connections and may optionally be guided by activation statistics or low-rank priors during training.

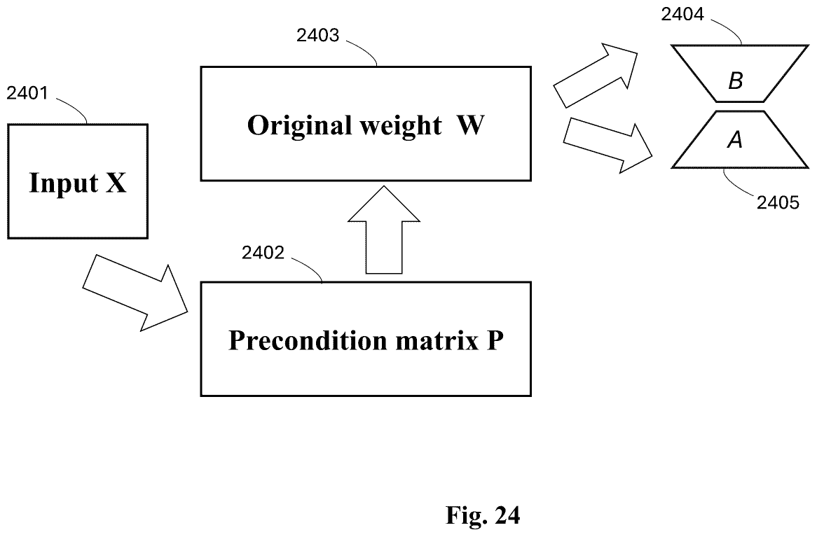

FIG. 24 is a diagram illustrating a preconditioning strategy for generating compressed representations from original model weights, according to some embodiments of the present disclosure.

An input activation X 2401 is used to derive a preconditioning matrix P 2402, which characterizes the input distribution or interaction statistics. This preconditioning matrix 2402 is applied to an original weight matrix W 2403, producing a transformed or decorrelated version of the weight prior to decomposition.

The preconditioned weight is then compressed into a low-rank factorization composed of matrices A 2404 and B 2405, which represent the basis functions or latent projections derived from the transformed space.

This method enhances the accuracy and efficiency of low-rank approximations by aligning the factorization with the structure of input activations. The preconditioner P is derived from covariance statistics, PCA, whitening transforms, or other domain-specific feature metrics, and, in some embodiments, is iteratively updated during training or compression.

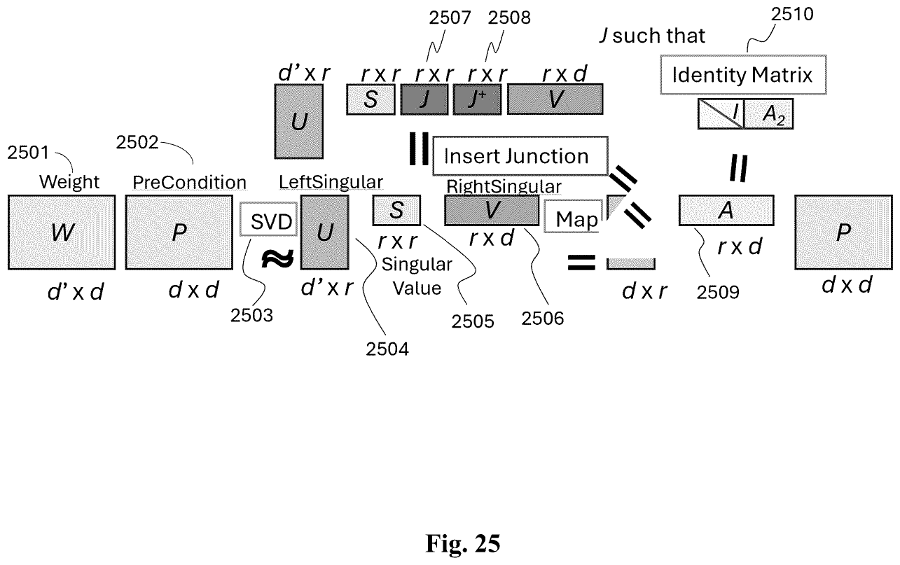

FIG. 25 is a diagram illustrating the use of a junction matrix J to enforce an identity structure in the left part of the compression matrix, according to some embodiments of the present disclosure.

An original weight matrix W 2501 of dimensions d′×d is preconditioned using a matrix P 2502, which, in embodiments, captures activation statistics or other input-informed transforms. The result WP undergoes a singular value decomposition (SVD 2503), yielding a left singular matrix U 2504 (d′×r), a diagonal singular value matrix S 2505 (r×r), and a right singular matrix V 2506 (r×d).

To facilitate structured compression, a junction matrix J 2507 may be inserted between S and V to produce a modified decomposition. The low-rank matrix B may be computed as B=U S J, and the matrix A may be computed as A=J⁺ V P⁺, where J⁺ (block 2508) is the pseudo-inverse of the junction matrix J. This decomposition allows degrees of freedom in shaping A and B while maintaining reconstruction accuracy.

The right singular matrix V 2506, in some embodiments, is partitioned into two subblocks: V₁ and V₂. When the junction matrix J is chosen as J=V₁, and V₁ is non-singular, the resulting compression matrix A 2509 is structured to contain an identity matrix block I in its left portion (see equation 10).

An identity matrix (block 2510) is explicitly placed into the matrix A 2509, reducing the need for redundant computation during inference. Block 2510 visually shows this mapping from a general right singular matrix V to a hybrid structured matrix A, composed of identity block I and residual term A₂=V₁⁺ V₂. This transformation preserves expressiveness while eliminating multiplications with identity blocks.

This formulation enables compression with fewer parameters and floating-point operations (FLOPs). Specifically, for an r & d matrix A where an r×r identity is embedded, the effective number of parameters and FLOPs may be reduced from r(d′+d) to r(d′+d)−r².

Accordingly, the diagram of FIG. 25 illustrates an SVD-based low-rank compression process enhanced with a junction matrix to enforce a left identity block within the compression matrix A, according to some embodiments. This identity-aware factorization offers practical benefits in LLMs and other deep models by simplifying computation while maintaining flexibility in the decomposition.

FIG. 26 is a diagram illustrating two conceptual frameworks for latent-space computation: explicit latent processes and implicit latent processes, according to some embodiments of the present disclosure.

On the left, a general model pipeline is shown, where input data X 2601 is processed using model weights W 2602 to produce outputs Y 2603. The process involves intermediate latent variables Z 2604 that capture structural or contextual representations not directly observable from inputs or outputs.

In the explicit latent process framework 2605, the latent variable Z is explicitly computed using a function G(W, X), shown in block 2606. This result is then passed to another function F(W, Z) (block 2607) that generates the output Y 2608. The flow is staged and decomposable:
W, X→Z→Y
with Z=G(W,X) and Y=F(W,Z).
   This approach lends itself well to modular analysis, interpretation, and compression because each transformation is functionally and temporally separated.

In contrast, the implicit latent process 2609 encodes the relationship between the variables through a constraint-based formulation. Here, a function H(W, X, Z, Y)=0 jointly defines the dependencies among the weights, inputs, latent variables, and outputs. The latent representation Z 2604 is not derived in a forward pass but is inferred as part of a solution to the constraint.

This implicit representation allows for more flexible modeling and is generally better suited for learning constraints, energy-based formulations, or inverse problems where latent states are not explicitly formed but inferred jointly with outputs.

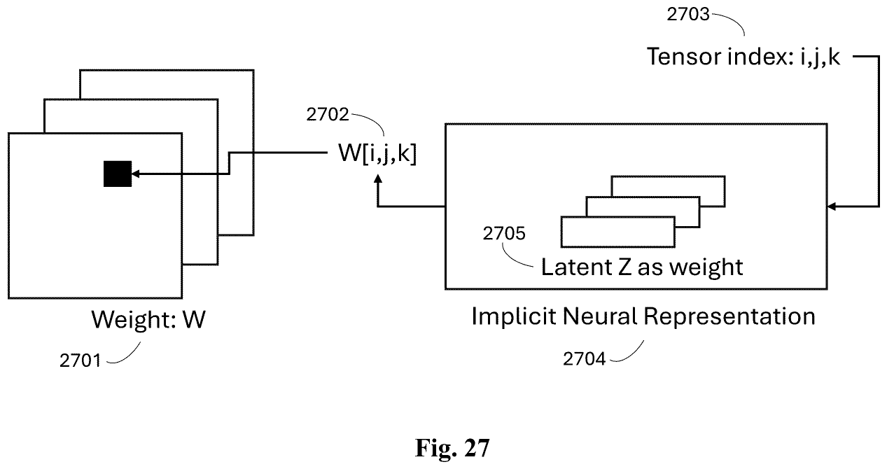

FIG. 27 is a diagram illustrating an implicit neural representation architecture where a latent representation is used to generate individual elements of a weight tensor, according to some embodiments of the present disclosure.

On the left, a multi-dimensional weight tensor W 2701 is shown. Rather than storing the full tensor explicitly, each element W[i, j, k] 2702 is generated procedurally using an index-based lookup.

The index triplet (i, j, k) 2703 is provided as input to a neural function, termed an implicit neural representation 2704, which maps these indices to the corresponding weight value. This function leverages a latent vector or field Z 2705 as internal parameters or contextual encoding.

The latent representation Z 2705 serves as a compressed encoding of the full weight tensor and may be much smaller in size. Instead of explicitly storing every weight, the network only learns this compact latent state and the neural mapping from indices to tensor values.

This approach allows for memory-efficient storage and continuous parametrization of weights, enabling dynamic weight reconstruction, flexible compression strategies, and integration with meta-learning or generative frameworks. The embodiment of FIG. 27 represents one implementation of using coordinate-based neural fields (e.g., NeRF-style architectures) or learned tensor decompositions for large model compression, which may be suitable for dense tensors like those found in LLMs or CNN layers.

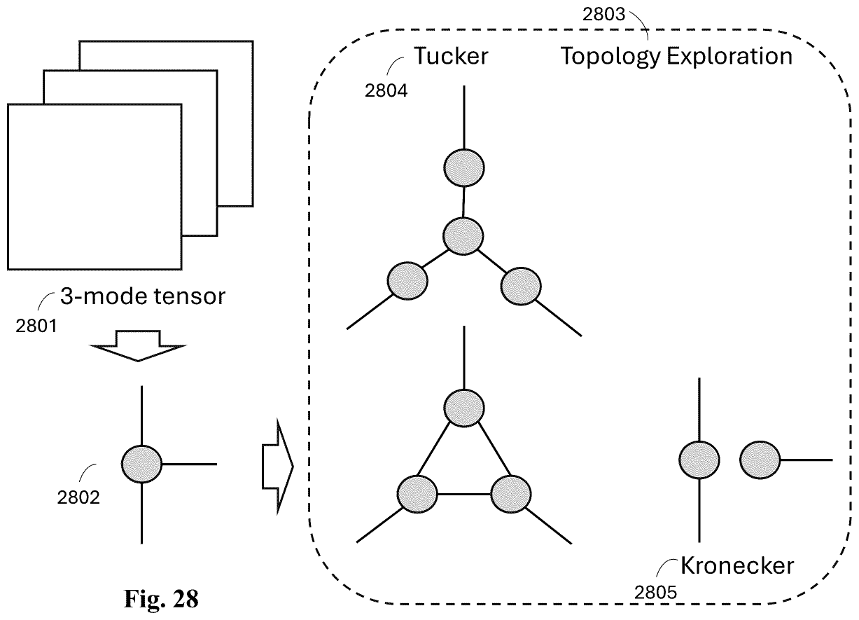

FIG. 28 is a schematic illustrating dynamic tensornet methods to compress weight parameters by exploring different topologies for reconfigurable decomposed tensors, according to some embodiments of the present disclosure.

On the left side of the figure, a 3-mode tensor 2801 is shown, which represents a stacked collection of neural network weights or other multi-dimensional data structures. This 3-mode tensor is represented using a tensor diagram 2802 composed of interconnected nodes and edges that encode modes and interactions between tensor dimensions.

Within topology exploration 2803, instead of applying a fixed decomposition scheme, the framework dynamically explores different tensor network topologies to optimize compression efficiency and reconstruction fidelity.

For instance, a Tucker decomposition 2804 is one candidate structure, breaking the original tensor into a core tensor connected to multiple factor matrices. Similarly, a Kronecker decomposition 2805 is also illustrated, modeling the tensor as a product of structured subcomponents.

This approach allows the system to search over a space of decomposition topologies, adaptively selecting tensor graph structures that balance compression ratio and approximation error. Such reconfigurability supports automated neural network compression pipelines and is particularly valuable in large-scale models where weight redundancies follow complex interdependencies.

The figure demonstrates that dynamic topology search within tensor networks (tensornets), rather than static decomposition, enables model-aware structural compression. The flexibility to navigate Tucker, Kronecker, or hybrid paths empowers the system to tailor compression schemes based on weight coupling, dimensionality, or statistical priors.

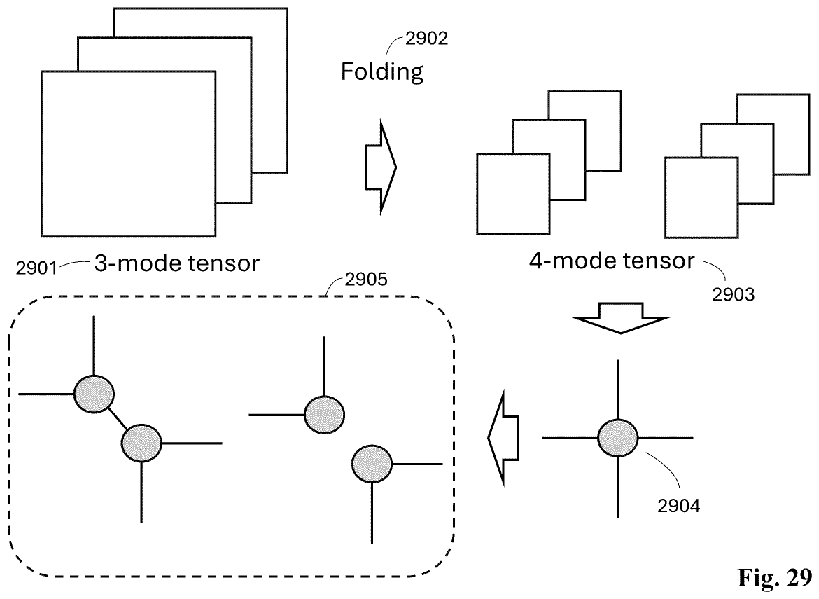

FIG. 29 is a schematic illustrating dynamic tensornet methods to compress weight parameters by exploring different topologies through tensor folding, according to some embodiments of the present disclosure.

A 3-mode tensor 2901 representing coupled weight parameters is shown on the left. To increase the expressivity of decomposition, the tensor is folded 2902 along one or more dimensions to construct a 4-mode tensor 2903. This transformation increases the degrees of freedom in the tensor structure and enables access to richer decomposition strategies.

Once folded, the 4-mode tensor 2903 is decomposed into multiple tensornet topologies 2905 using tensor diagram notation 2904. Tensornet topologies 2905 illustrate several candidate configurations for tensornet factorization, such as disconnected components, partially shared nodes, or fully connected latent cores. These variants reflect distinct structural priors that are evaluated to determine the most effective low-rank representation.

The goal of folding and dynamic topology selection is to uncover decompositions that better align with the latent structure of the model parameters while reducing redundancy. By folding to higher-order tensors before decomposition, the framework improves compressibility, especially in the context of complex architectures like transformers or convolutional networks.

This flexible approach generalizes beyond static decomposition pipelines and enables automated architecture search over tensornet layouts to balance compression, reconstruction fidelity, and downstream task performance.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A neural network model having an architecture comprising:
an input module configured to receive input data;
a first module associated with a first weight matrix and a second module associated with a second weight matrix, wherein the first module is functionally coupled to the second module, and wherein the first and second modules are collectively configured to transform the input data into output data based on an interaction between the first and second weight matrices;
a compressed representation of the interaction between the first and second weight matrices, the compressed representation being defined in a reduced-dimensional latent space and configured to perform the interaction during the transformation of the input data into the output data, in place of or in approximation of the interaction between the first and second weight matrices; and
an output module configured to output a result based on the interaction resulting in the output data.

2. A method for determining the compressed representation of claim 1, the method comprising:
receiving the first weight matrix associated with the first module and the second weight matrix associated with the second module, the first and second modules being functionally coupled;
processing a set of input data using the first and second weight matrices to generate original activation outputs resulting from the interaction between the first and second modules;
computing one or more activation statistics based on the original activation outputs, the activation statistics characterizing functional behavior of the interaction; and
determining the compressed representation of the interaction based at least in part on the activation statistics, the compressed representation being configured to approximate the interaction between the first and second modules with reduced dimensionality or parameter complexity.

3. The method of claim 2, wherein the compressed representation is determined by minimizing a reconstruction loss between the original activation output of the interaction and a simulated activation output computed using the compressed representation.

4. The method of claim 2, wherein determining the compressed representation comprises performing a joint matrix or tensor decomposition on the first and second weight matrices based on the activation statistics, the decomposition including one or a combination of a singular value decomposition (SVD), a Tucker decomposition, and a canonical polyadic (CP) decomposition.

5. The neural network model of claim 1, the compressed representation comprising:
a latent input projection matrix configured to project the input data into a reduced-dimensional latent space; and
a core matrix or tensor defined in the latent space and configured to transform the latent projection to approximate the interaction between the first and second weight matrices.

6. The neural network model of claim 5, wherein the latent input projection matrix and the core matrix or tensor are obtained through a joint tensor decomposition of the first and second weight matrices using Tucker decomposition, and wherein the compressed representation is optimized to minimize a loss function based on a difference between the original interaction and the compressed interaction.

7. The neural network model of claim 6, wherein the loss function is based on an error in a functional interaction comprising a dot-product between projected inputs, such that the compressed representation approximates an attention map generated by the original interaction.

8. The neural network model of claim 1, wherein at least one of the first weight matrix or the second weight matrix is generated from a latent parameter vector using a hypernetwork.

9. The neural network model of claim 5, wherein at least one of the latent input projection matrix or the core matrix or tensor is generated, at least in part, from a latent parameter vector using a hypernetwork.

10. The neural network model of claim 1, wherein at least one of the first or second weight matrices is implicitly defined by a compact neural network configured to generate weight values in response to latent input parameters.

11. The neural network model of claim 1, wherein at least one of the latent input projection matrix or the core matrix or tensor is implicitly defined by a compact neural network configured to generate matrix or tensor values in response to latent input parameters.

12. The neural network model of claim 1, wherein the first module comprises a query projection and the second module comprises a key projection of an attention mechanism, and wherein the interaction approximated by the compressed representation comprises an attention map generated by a dot-product between the query and key projections.

13. The neural network model of claim 1, wherein the first module is part of an encoder and the second module is part of a decoder in a sequence-to-sequence architecture, and wherein the interaction approximated by the compressed representation comprises a transformation of encoded representations into decoded outputs.

14. The neural network model of claim 1, wherein the first module comprises an up-projection layer and the second module comprises a down-projection layer of a multi-layer perceptron (MLP), and wherein the interaction approximated by the compressed representation corresponds to a transformation between input and output representations of the MLP.

15. A method for generating a compressed representation of an interaction between a first weight matrix and a second weight matrix in a neural network model, the method comprising:
receiving input data associated with a first module and a second module of the neural network model, wherein the first module is functionally coupled to the second module through an interaction between the first weight matrix and the second weight matrix;
determining a latent input projection matrix configured to project the input data into a reduced-dimensional latent space; and
determining a core matrix or tensor defined in the latent space and configured to transform the latent projection of the input data to approximate the interaction between the first and second weight matrices.

16. The method of claim 15, further comprising:
receiving the neural network model comprising the first weight matrix associated with the first module and the second weight matrix associated with the second module; and
generating the latent input projection matrix and the core matrix or tensor based on the first and second weight matrices, such that the core matrix or tensor approximates an interaction between the first and second weight matrices when operating in a reduced-dimensional latent space.

17. The method of claim 15, further comprising:
optimizing the latent input projection matrix and the core matrix or tensor to minimize a loss function based on a difference between an output of the compressed interaction and an output of the original interaction between the first and second weight matrices.

18. The method of claim 15, wherein the latent input projection matrix and the core matrix or tensor are obtained by performing a joint tensor decomposition using Tucker decomposition on the first and second weight matrices.

19. The method of claim 15, wherein the interaction between the first and second weight matrices corresponds to a dot-product operation between query and key projections of an attention mechanism.

20. The method of claim 15, wherein the latent input projection matrix is shared across multiple pairs of weight matrices associated with different layers or modules of the neural network model.

21. The method of claim 15, wherein the latent input projection matrix and the core matrix or tensor are determined without fine-tuning the neural network model on task-specific data, and wherein using the latent input projection matrix and the core matrix or tensor reduces a number of floating-point operations required to compute the interaction compared to using the original first and second weight matrices.

22. A neural network model having an architecture including an attention mechanism comprising:
a query projection module configured to generate query vectors from input data using a first weight matrix;
a key projection module configured to generate key vectors from the input data using a second weight matrix, wherein the query projection module and the key projection module are functionally coupled such that an attention map is computed based on an interaction between the first and second weight matrices;
a compressed representation of the interaction between the first and second weight matrices, the compressed representation comprising:
a latent input projection matrix configured to project the input data into a reduced-dimensional latent space; and
a core matrix or tensor defined in the latent space and configured to transform the latent projection to approximate the interaction between the query and key projections; and
an attention computation module configured to compute an attention map using the compressed representation in place of or in approximation of the original interaction between the first and second weight matrices and output a result based on the interaction.
